(19) United States
(12) Patent Application Publication
(10) Pub. No.: US 2011/0077330 A1
(43) Pub. Date: Mar. 31, 2011

(54) POLYCARBONATE RESIN COMPOSITION CONTAINING TRIAZINE COMPOUND AND MOLDED ARTICLE USING THE SAME

(75) Inventors: Ichiro Amasaki, Odawara-shi (JP); Keizo Kimura, Odawara-shi (JP)

(73) Assignee: FUJIFILM Corporation, Minato-ku (JP)

(21) Appl. No.: 12/890,822

(22) Filed: Sep. 27, 2010

(30) Foreign Application Priority Data
Sep. 28, 2009 (JP) 2009-223467

(51) Int. Cl. C08K 5/3492

(52) U.S. Cl. 524/100

(57) ABSTRACT

A polycarbonate resin composition containing a compound represented by the following formula (1):

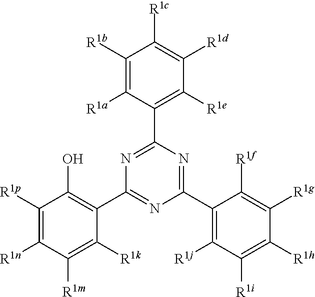

wherein each of R^{1a}, R^{1b}, R^{1c}, R^{1d} and R^{1e} independently represents a hydrogen atom or a monovalent substituent excluding —OH, at least one of the substituents represents a substituent having a positive Hammett's σp value, and the substituents may be combined each other to form a ring; each of R^{1f}, R^{1g}, R^{1h}, R¹ⁱ and R^{1j} independently represents a hydrogen atom or a monovalent substituent excluding —OH, and the substituents may be combined each other to form a ring; and each of R^{1k}, R^{1m}, R¹ⁿ and R^{1p} independently represents a hydrogen atom or a monovalent substituent, and the substituents may be combined each other to form a ring.

### BACKGROUND OF THE INVENTION

1. Field of the Invention

The present invention relates to a polycarbonate resin composition containing a triazine compound, and a molded article using the composition.

2. Description of the Related Art

Conventionally, it has been done to impart ultraviolet absorptivity by using an ultraviolet absorber in combination with various resins or the like. An inorganic ultraviolet absorber or an organic ultraviolet absorber is used as the ultraviolet absorber. In the case of an inorganic ultraviolet absorber (see, for example, Patent Documents 1 to 3), the durability such as weather resistance and heat resistance is excellent, but the latitude of selection is narrow, because the absorption wavelength is determined by the band gap of the compound. Moreover, an absorber capable of absorbing light even in the long-wavelength ultraviolet ray (UV-A) region of around 400 nm is not known, and an absorber capable of absorbing light in the long-wavelength ultraviolet light, if any, absorbs light also in the visible region and therefore, involves coloring.

In contrast, the organic ultraviolet absorber has a wide latitude in designing the absorber structure and therefore, absorbers having various absorption wavelengths can be obtained by designing the absorber structure.

Systems using various organic ultraviolet absorbers have been heretofore studied, and Patent Document 4 discloses a triazole-based ultraviolet absorber. However, those having a maximum absorption wavelength in the long-wavelength ultraviolet range are poor in the light resistance, and their ultraviolet-blocking effect wears off with the passage of time.

Furthermore, a material applied to a solar cell or the like recently under development must be exposed to sunlight outdoors for a long period of time, and the exposure to ultraviolet ray over long term aging unavoidably obliges the material to undergo a change in the color hue as time passes. Accordingly, an ultraviolet-absorbing resin composition exhibiting a blocking effect even in the UV-A region and having a higher light resistance than ever and a molded article formed using the composition are demanded.

[Patent Document 1] JP-A-5-339033 (the term “JP-A” as used herein means an “unexamined published Japanese patent application”)

[Patent Document 2] JP-A-5-345639

[Patent Document 3] JP-A-6-56466

[Patent Document 4] JP-T-2002-524452 (the term “JP-T” as used herein means a published Japanese translation of a PCT patent application)

### SUMMARY OF THE INVENTION

An object of the present invention is to provide a polycarbonate resin composition capable of maintaining a long-wavelength ultraviolet-blocking effect for a long period of time and endowed with excellent light resistance. Another object of the present invention is to provide a molded article such as ultraviolet filter free from a change in the color hue with long term aging.

As a result of intensive studies to attain the objects above, the present inventors have found that when a novel compound exhibiting a blocking effect even in the UV-A region and having an unprecedented light resistance is incorporated into a polycarbonate resin composition, an excellent molded article free from a change in the color hue with aging can be provided. The present invention has been accomplished based on this finding.

The objects of the present invention have been attained by the following techniques.

(1) A polycarbonate resin composition containing a compound represented by the following formula (1):

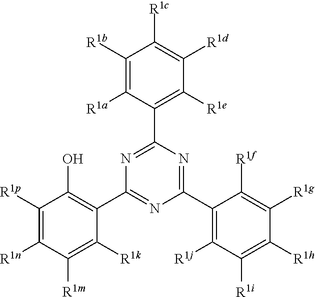

wherein each of R^{1a}, R^{1b}, R^{1c}, R^{1d} and R^{1e} independently represents a hydrogen atom or a monovalent substituent excluding —OH, at least one of the substituents represents a substituent having a positive Hammett's σp value, and the substituents may be combined each other to form a ring;

each of R^{1f}, R^{1g}, R^{1h}, R¹ⁱ and R^{1j} independently represents a hydrogen atom or a monovalent substituent excluding —OH, and the substituents may be combined each other to form a ring; and

each of R^{1k}, R^{1m}, R¹ⁿ and R^{1p} independently represents a hydrogen atom or a monovalent substituent, and the substituents may be combined each other to form a ring.

(2) The polycarbonate resin composition according to the above (1), wherein said monovalent substituent is a halogen atom, a substituted or unsubstituted alkyl group having a carbon number of 1 to 20, a cyano group, a carboxyl group, a substituted or unsubstituted alkoxycarbonyl group, a substituted or unsubstituted carbamoyl group, a substituted or unsubstituted alkylcarbonyl group, a nitro group, a substituted or unsubstituted amino group, a hydroxy group, an alkoxy group having a carbon number of 1 to 20, a substituted or unsubstituted aryloxy group, a substituted or unsubstituted sulfamoyl group, a thiocyanate group, or a substituted or unsubstituted alkylsulfonyl group,

and in the case of having a substituent, the substituent is a halogen atom, an alkyl group having a carbon number of 1 to 20, a cyano group, a carboxyl group, an alkoxycarbonyl group, a carbamoyl group, an alkylcarbonyl group, a nitro group, an amino group, a hydroxy group, an alkoxy group having a carbon number of 1 to 20, an aryloxy group, a sulfamoyl group, a thiocyanate group, or an alkylsulfonyl group.

(3) The polycarbonate resin composition according to the above (1) or (2), wherein R^{1c} is a substituent having a positive Hammett's σp value.
(4) The polycarbonate resin composition according to any one of the above (1) to (3), wherein said Hammett's σp value is from 0.1 to 1.2.
(5) The polycarbonate resin composition according to any one of the above (1) to (4), wherein said substituent having a positive Hammett's σp value is a group selected from COOR^{r}, CONR^{s}₂, CN, CF₃, a halogen atom, NO₂, SO₂R^{t} and SO₃M, wherein each of R^{r}, R^{s} and R^{t} represents a hydrogen atom or a monovalent substituent, and M represents a hydrogen atom or an alkali metal.
(6) The polycarbonate resin composition according to any one of the above (1) to (5), wherein said substituent having a positive Hammett's σp value is COOR^{r}, wherein R^{r} represents a hydrogen atom or a monovalent substituent.
(7) The polycarbonate resin composition according to any one of the above (1) to (6), wherein R^{1c} is CN.
(8) The polycarbonate resin composition according to any one of the above (1) to (7), wherein R¹ⁿ is OR^{u} wherein R^{u} represents a hydrogen atom or a monovalent substituent.
(9) The polycarbonate resin composition according to any one of the above (1) to (8), wherein R^{u} is an alkyl group having a carbon number of 1 to 20.
(10) The polycarbonate resin composition according to any one of the above (1) to (9), wherein pKa is from −5.0 to −7.0.
(11) The polycarbonate resin composition according to any one of the above (1) to (10), which further contains a phosphorus-based stabilizer.
(12) The polycarbonate resin composition according to any one of the above (1) to (11), wherein the compound represented by formula (1) is contained in an amount of from 0.05 to 3 parts by mass and the phosphorus-based stabilizer is contained in an amount of from 0.0005 to 0.3 parts by mass, per 100 parts by mass of the polycarbonate resin composition.
(13) The polycarbonate resin composition according to any one of the above (1) to (12), which further contains a hindered phenol-based stabilizer.
(14) The polycarbonate resin composition according to any one of the above (1) to (13), wherein the viscosity average molecular weight of the polycarbonate resin is from 10,000 to 50,000.
(15) A molded article comprising the polycarbonate resin composition according to any one of the above (1) to (14).

The polycarbonate resin composition of the present invention contains a compound represented by formula (1) capable of exhibiting high light fastness even in the long-wavelength ultraviolet region, so that the obtained molded article and the contents therein can be enhanced in the photostability.

The molded article of the present invention is obtained by shaping the polycarbonate resin composition above and has an excellent long-wavelength ultraviolet absorbing ability, so that the molded article can be free from a change in the color hue with long term aging and can be used as an ultraviolet-absorbing filter or container.

### DETAILED DESCRIPTION OF THE INVENTION

The present invention is described in detail below.

The present invention relates to a polycarbonate resin composition containing a compound represented by the following formula (1).

The compound represented by the following formula (1) is described below.

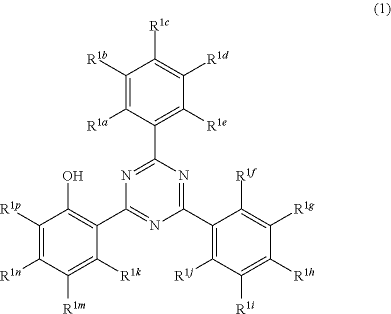

wherein each of R^{1a}, R^{1b}, R^{1c}, R^{1d} and R^{1e} independently represents a hydrogen atom or a monovalent substituent excluding —OH, at least one of the substituents represents a substituent having a positive Hammett's σp value, and the substituents may be combined each other to form a ring; each of R^{1f}, R^{1g}, R^{1h}, R¹ⁱ and R^{1j} independently represents a hydrogen atom or a monovalent substituent excluding —OH, and the substituents may be combined each other to form a ring; and each of R^{1k}, R^{1m}, R¹ⁿ and R^{1p} P independently represents a hydrogen atom or a monovalent substituent, and the substituents may be combined each other to form a ring.

Each of R^{1a}, R^{1b}, R^{1c}, R^{1d} and R^{1e} independently represents a hydrogen atom or a monovalent substituent excluding —OH, and at least one of the substituents represents a substituent having a positive Hammett's σp value.

Out of R^{1a}, R^{1b}, R^{1c}, R^{1d}, R^{1e}, preferably, one to three members represent a substituent having a positive Hammett's σp value; and more preferably, one or two members represent a substituent having a positive Hammett's σp value.

Also, out of R^{1a}, R^{1c} and R^{1e}, preferably, at least one member represents a substituent having a positive Hammett's σp value; and more preferably, R^{1c} represents a substituent having a positive Hammett's σp value.

It is still more preferred that R^{1c} is a substituent having a positive Hammett's σp value and each of R^{1a}, R^{1b}, R^{1d} and R^{1e} represents a hydrogen atom.

In the case where R^{1c} is a substituent having a positive Hammett's σp value, LUMO is stabilized by an electron-withdrawing group and this is preferred because the excitation life becomes short and the light resistance is enhanced.

Examples of the monovalent substituent (hereinafter referred to as the substituent A) in formula (1) include a halogen atom (e.g., fluorine atom, chlorine atom, bromine atom, iodine atom), an alkyl group having a carbon number of 1 to 20 (e.g., methyl, ethyl), an aryl group having a carbon number of 6 to 20 (e.g., phenyl, naphthyl), a cyano group, a carboxyl group, an alkoxycarbonyl group (e.g., methoxycarbonyl), an aryloxycarbonyl (e.g., phenoxycarbonyl), a substituted or unsubstituted carbamoyl group (e.g., carbamoyl, N-phenylcarbamoyl, N,N-dimethylcarbamoyl), an alkylcarbonyl (e.g., acetyl), an arylcarbonyl group (e.g., benzoyl), a nitro group, a substituted or unsubstituted amino group (e.g. amino, dimethylamino, anilino, substituted sulfoamino), an acylamino group (e.g., acetamide, ethoxycarbonylamino), a sulfonamido group (e.g., methanesulfonamido), an imido group (e.g., succinimido, phthalimido), an imino group (e.g., benzylideneamino), a hydroxy group, an alkoxy group having a carbon number of 1 to 20 (e.g., methoxy), an aryloxy group (e.g., phenoxy), an acyloxy group (e.g., acetoxy), an alkylsulfonyloxy group (e.g., methanesulfonyloxy), an arylsulfonyloxy group (e.g., benzenesulfonyloxy), a sulfo group, a substituted or unsubstituted sulfamoyl group (e.g., sulfamoyl, N-phenylsulfamoyl), an alkylthio group (e.g., methylthio), an arylthio group (e.g., phenylthio), a thiocyanate group, an alkylsulfonyl group (e.g., methanesulfonyl), an arylsulfonyl group (e.g., benzenesulfonyl), and a heterocyclic group having a carbon number of 6 to 20 (e.g., pyridyl, morpholino).

The substituent may be further substituted and when a plurality of substituents are present, they may be the same or different. In this case, examples of the substituent include the above-described monovalent substituent A. Also, the substituents may be combined each other to form a ring.

Examples of the ring fowled by combining the substituents with each other include a benzene ring, a pyridine ring, a pyrazine ring, a pyrimidine ring, a triazine ring, a pyridazine ring, a pyrrole ring, a pyrazole ring, an imidazole ring, a triazole ring, an oxazole ring, an oxadiazole ring, a thiazole ring, a thiadiazole ring, a furan ring, a thiophene ring, a selenophene ring, a silole ring, a germole ring, and a phosphole ring.

The monovalent substituent in formula (1) is preferably a halogen atom, a substituted or unsubstituted alkyl group having a carbon number of 1 to 20, a cyano group, a carboxyl group, a substituted or unsubstituted alkoxycarbonyl group, a substituted or unsubstituted carbamoyl group, a substituted or unsubstituted alkylcarbonyl group, a nitro group, a substituted or unsubstituted amino group, a hydroxy group, a substituted or unsubstituted alkoxy group having a carbon number of 1 to 20, a substituted or unsubstituted aryloxy group, a substituted or unsubstituted sulfamoyl group, a thiocyanate group, or a substituted or unsubstituted alkylsulfonyl group, more preferably OR^{u} (R^{u} represents a hydrogen atom or a monovalent substituent), an alkyl group or an amido group, still more preferably OR^{u} or an alkyl group.

R^{u} represents a hydrogen atom or a monovalent substituent, and examples of the monovalent substituent include the substituent A. In particular, a linear or branched alkyl group having a carbon number of 1 to 20 is preferred, and a linear or branched alkyl group having a carbon number of 1 to 6 is more preferred. Examples of the linear or branched alkyl group having a carbon number of 1 to 6 include methyl, ethyl, n-propyl, i-propyl, n-butyl, i-butyl, s-butyl, tert-butyl, n-pentyl, i-pentyl, tert-pentyl, n-hexyl, i-hexyl, text-hexyl, n-octyl, tert-octyl and i-octyl. Among these, methyl and ethyl are preferred, and methyl is more preferred.

In the compound represented by formula (1), R¹ⁿ development represents a monovalent substituent, and R¹ⁿ more preferably represents OR^{u}. It is still more preferred that R¹ⁿ represents OR^{u} and all of R^{1k}, R^{1m} and R^{1p} represent a hydrogen atom, because the molar extinction coefficient becomes large and the blocking effect increases.

In formula (1), the substituent having a positive Hammett's σp value is preferably an electron-withdrawing group having a σp value of 0.1 to 1.2. Specific examples of the electron-withdrawing group having a σp value of 0.1 or more include COOR^{r} (R^{r} represents a hydrogen atom or a monovalent substituent), CONR^{s}₂ (R^{s} represents a hydrogen atom or a monovalent substituent), CN, a halogen atom, NO₂, SO₂R^{t} (R^{t} represents a hydrogen atom or a monovalent substituent), SO₃M (M represents a hydrogen atom or an alkali metal), an acyl group, a formyl group, an acyloxy group, an acylthio group, an alkyloxycarbonyl group, an aryloxycarbonyl group, a dialkylphosphono group, a diarylphosphono group, a dialkylphosphinyl group, a diarylphosphinyl group, a phosphoryl group, an alkylsulfinyl group, an arylsulfinyl group, an acylthio group, a sulfamoyl group, a thiocyanate group, a thiocarbonyl group, an imino group, an N atom-substituted imino group, a carboxy group (or a salt thereof), an alkyl group substituted with at least two or more halogen atoms (e.g., CF₃), an alkoxy group substituted with at least two or more halogen atoms, an aryloxy group substituted with at least two or more halogen atoms, an acylamino group, an alkylamino group substituted with at least two or more halogen atoms, an alkylthio group substituted with at least two or more halogen atoms, an aryl group substituted with another electron-withdrawing group having a σp value of 0.2 or more, a heterocyclic group, a halogen atom, an azo group, and a selenocyanate group. Details of the Hammett's σp value are described in C. Hansch, A. Leo and R. W. Taft, Chem. Rev., 1991, 91, 165-195.

In formula (1), the substituent having a positive Hammett's σp value is more preferably COOR^{r}, CONR^{s}₂, CN, CF₃, a halogen atom, NO₂, SO₂R^{t} or SO₃M [wherein each of R^{r} and R^{s} represents a hydrogen atom or a monovalent substituent, and M represents a hydrogen atom or an alkali metal], still more preferably COOR^{r} or CN, yet still more preferably COOR^{r} because of excellent light resistance and solubility.

R^{r} represents a hydrogen atom or a monovalent substituent, and examples of the monovalent substituent include the substituent A. In particular, a linear or branched alkyl group having a carbon number of 1 to 20 is preferred, and a linear or branched alkyl group having a carbon number of 1 to 6 is more preferred. Examples of the linear or branched alkyl group having a carbon number of 1 to 6 include methyl, ethyl, n-propyl, i-propyl, n-butyl, i-butyl, s-butyl, tert-butyl, n-pentyl, i-pentyl, tert-pentyl, n-hexyl, i-hexyl, tert-hexyl, tert-octyl, i-octyl and n-octyl. Among these, methyl and ethyl are preferred, and methyl is more preferred.

In the compound represented by formula (1), R^{1c} is preferably any one of COOR^{r}, CONR^{s}₂, CN, CF₃, a halogen atom, NO₂, SO₂R^{t} and SO₃M, more preferably COOR^{r} or CN.

In the present invention, preferably, at least one of R^{1f}, R^{1g}, R^{1h}, R¹ⁱ, R^{1j}, R^{1k}, R^{1m} R¹ⁿ and R^{1p} represents the above-described substituent having a positive Hammett's σp value; more preferably, at least one of R^{1f}, R^{1g}, R^{1h}, R¹ⁱ and R^{1j} represents the above-described substituent having a positive Hammett's σp value; and still more preferably, R^{1h} represents the above-described substituent having a positive Hammett's σp value.

In particular, it is preferred that both R^{1c} and R^{1h} represent the above-described substituent having a positive Hammett's σp value.

This is because the compound has excellent light resistance.

The compound represented by formula (1) preferably has a pKa of −5.0 to −7.0, more preferably from −5.2 to −6.5, still more preferably −5.4 to −6.0.

Specific examples of the compound represented by formula (1) are illustrated below, but the present invention is not limited thereto.

In specific examples, Me represents a methyl group, Ph represents a phenyl group, and —C₆H₁₃ represents an n-hexyl.

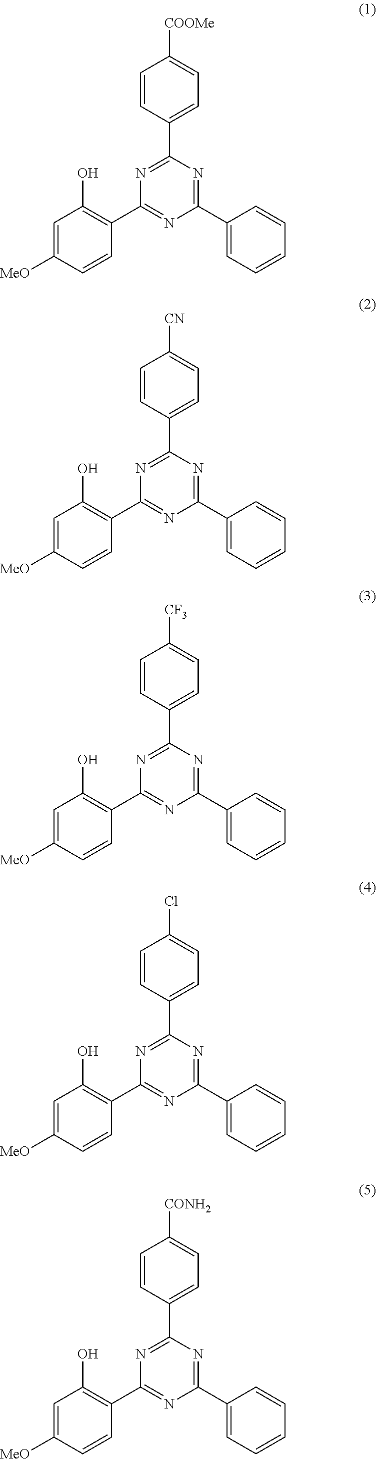

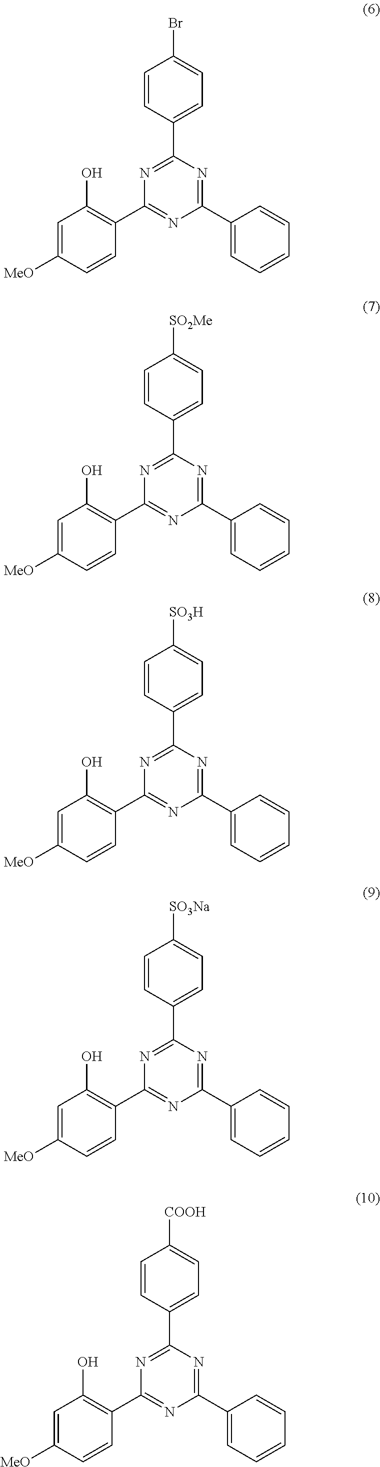

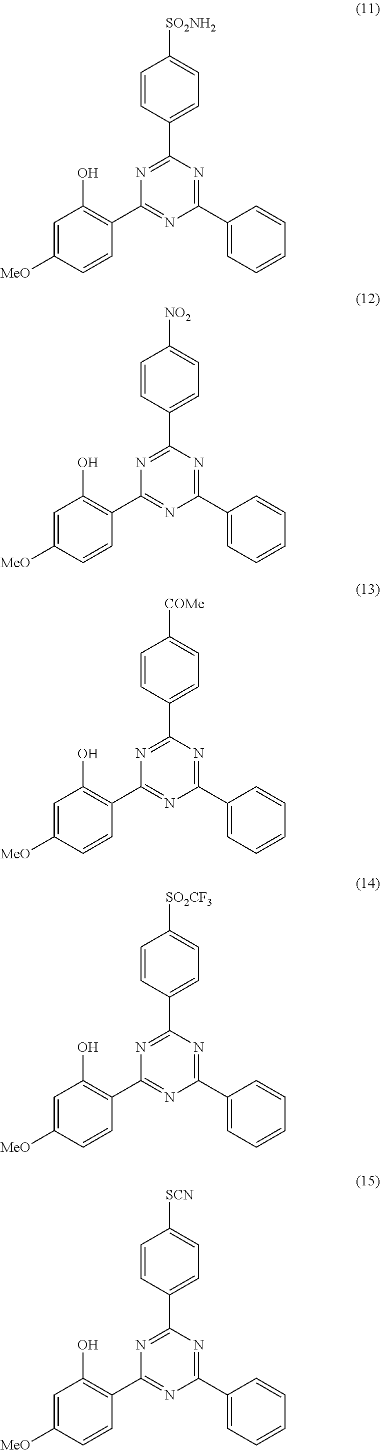

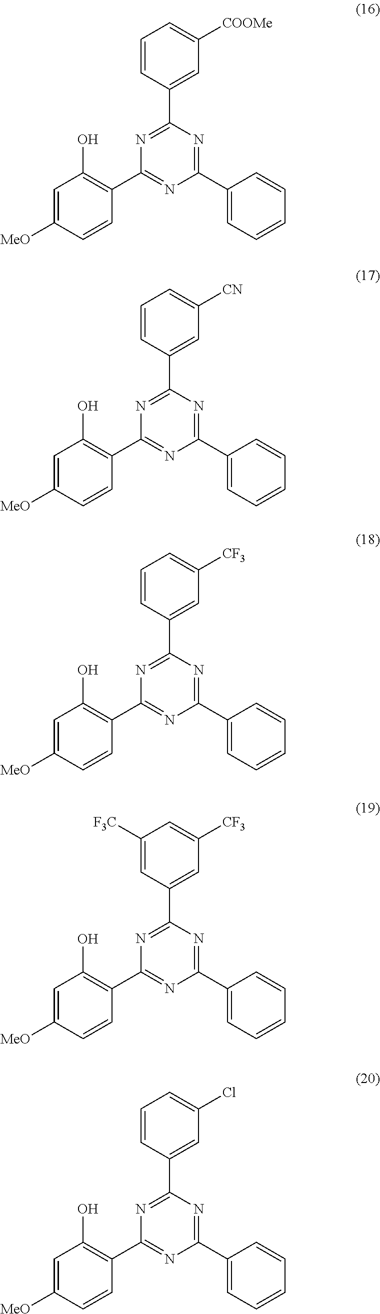

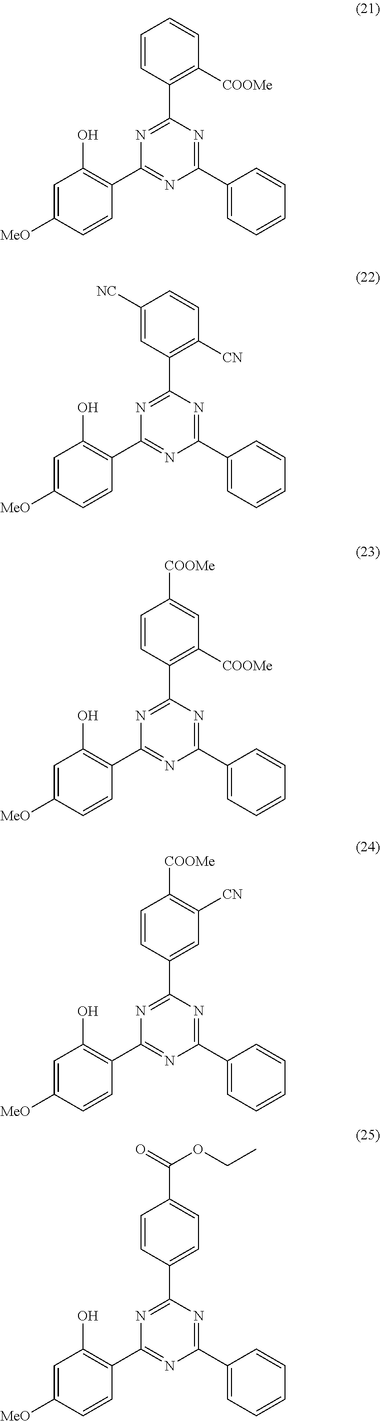

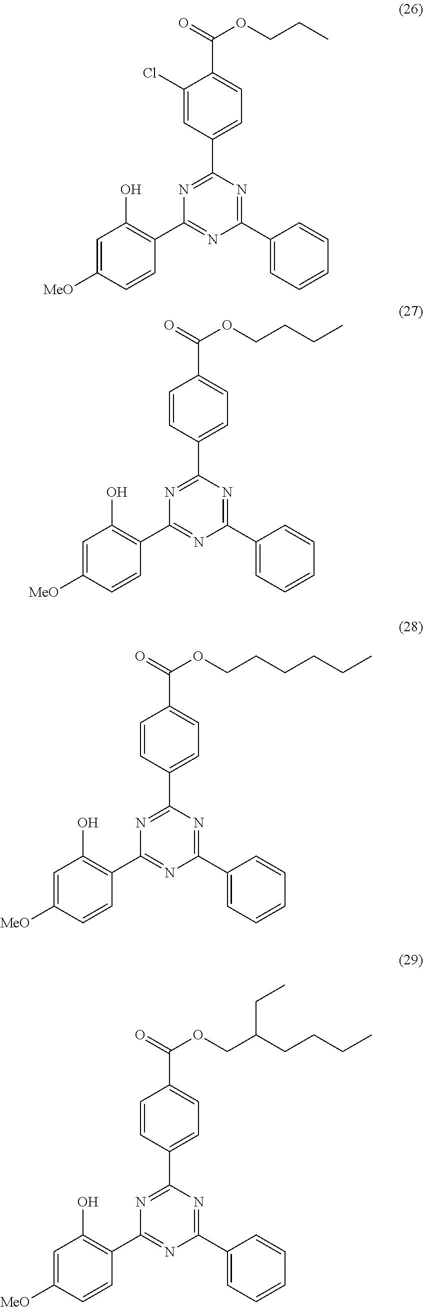

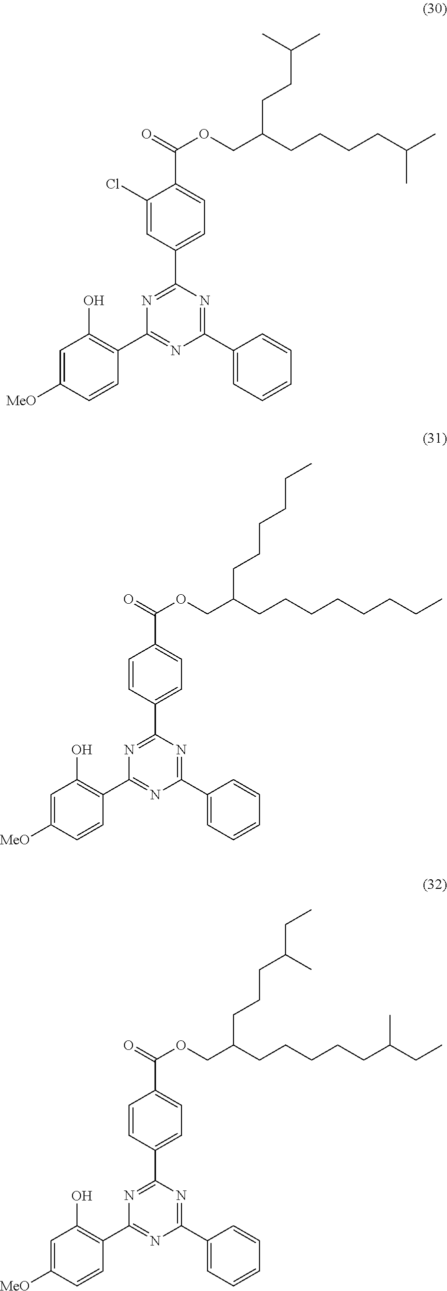

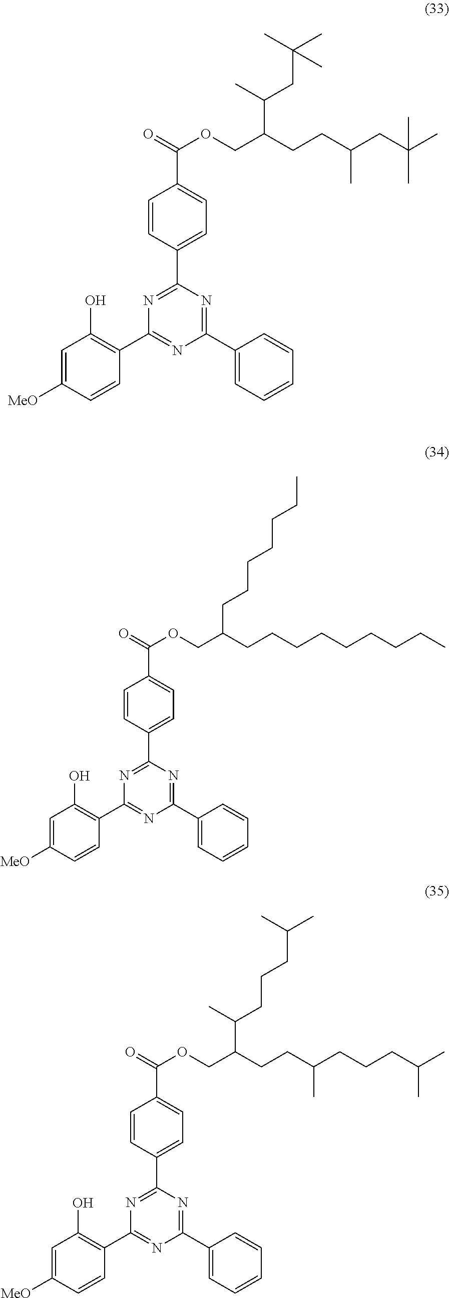

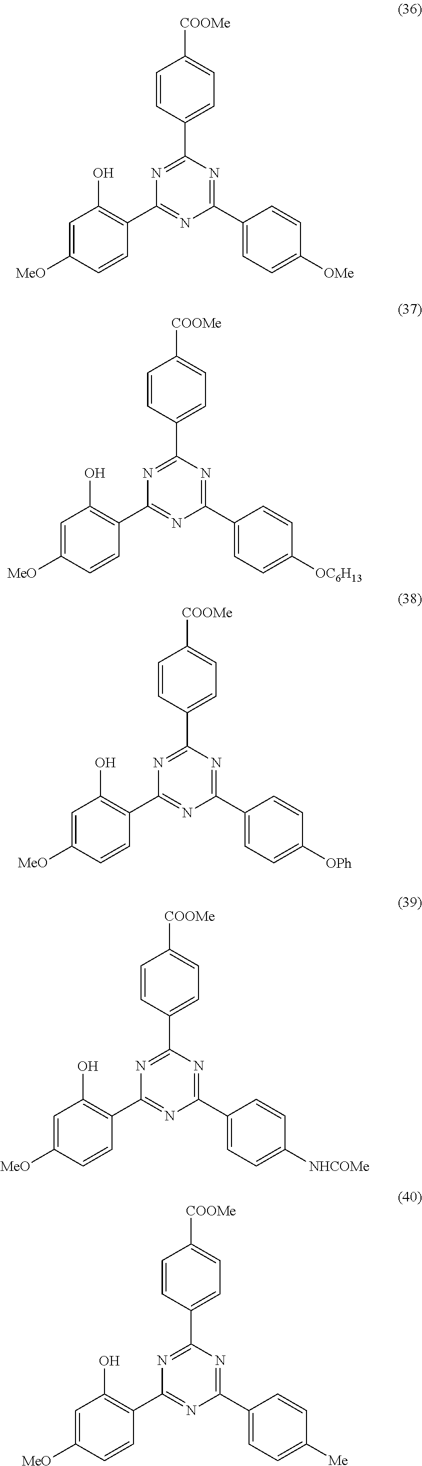

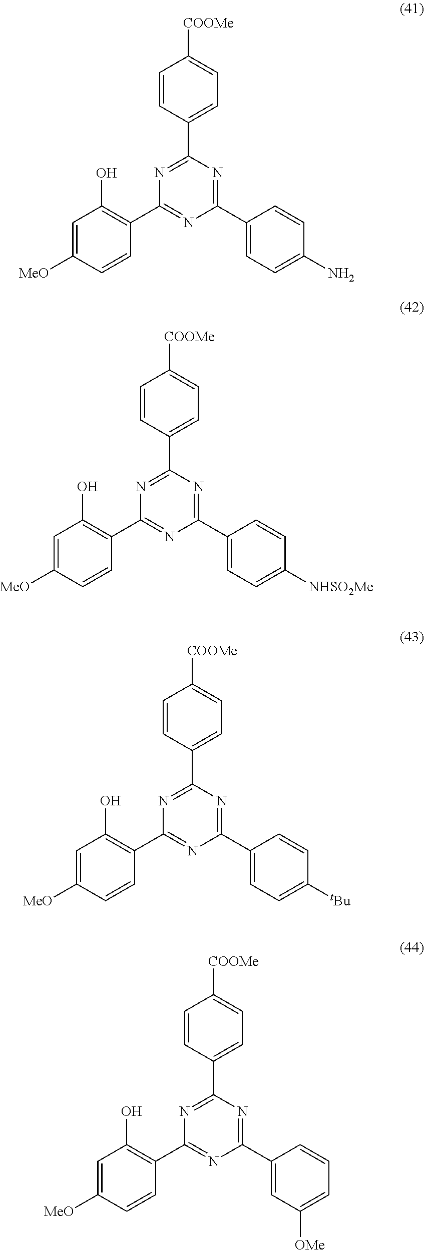

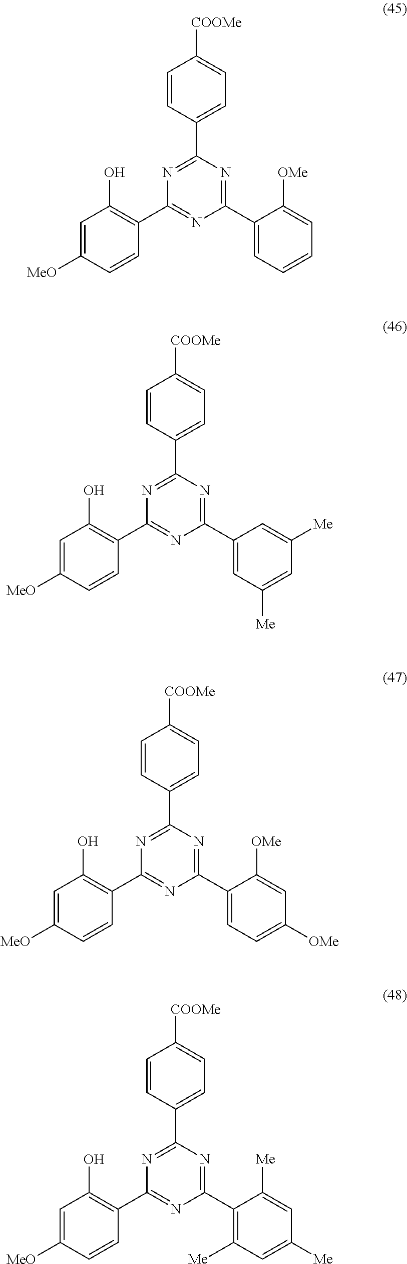

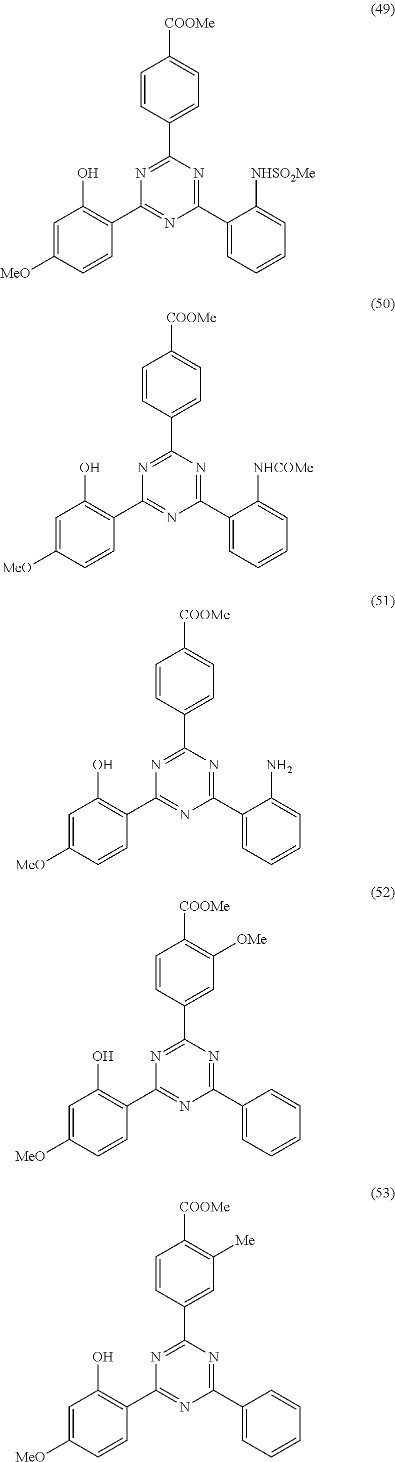

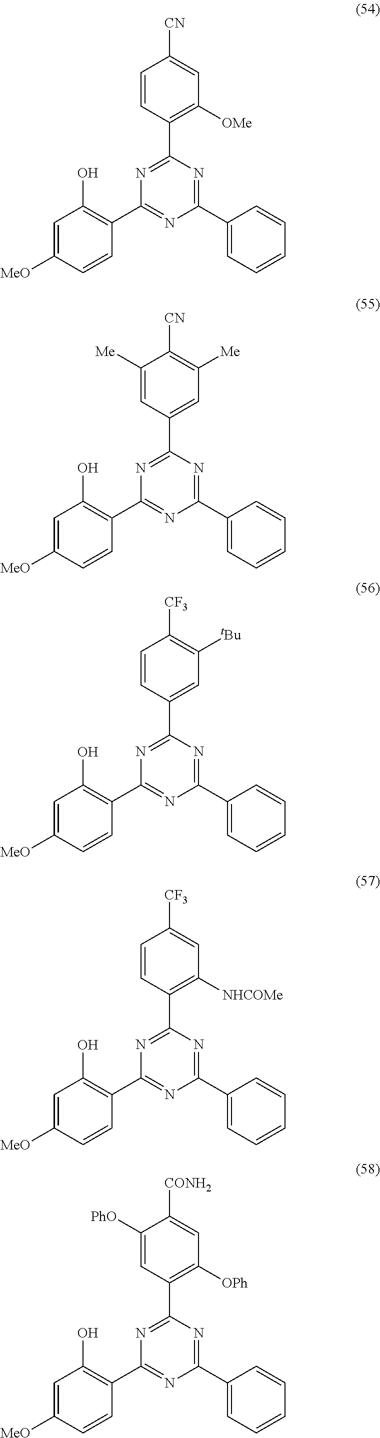

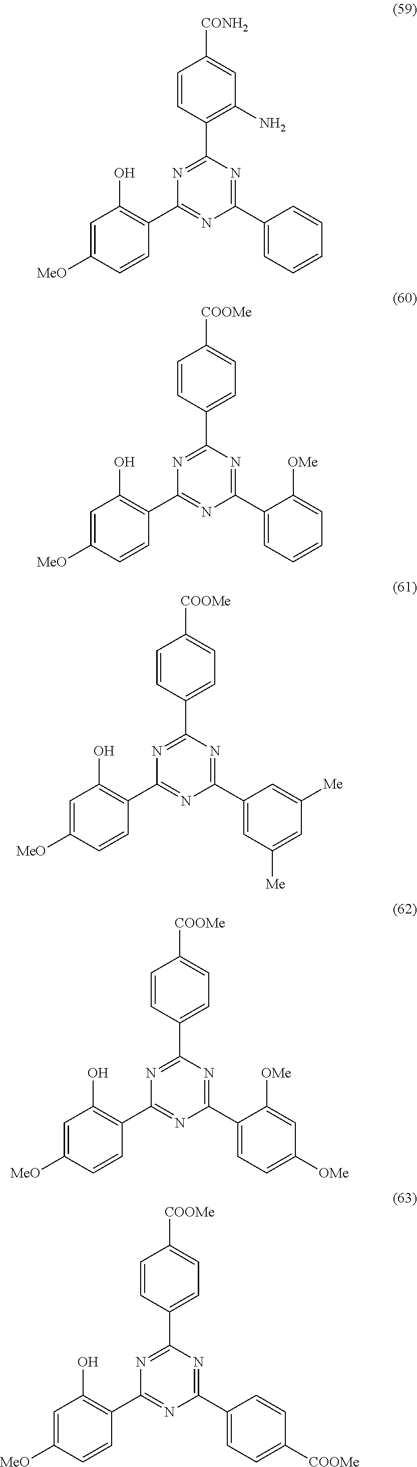

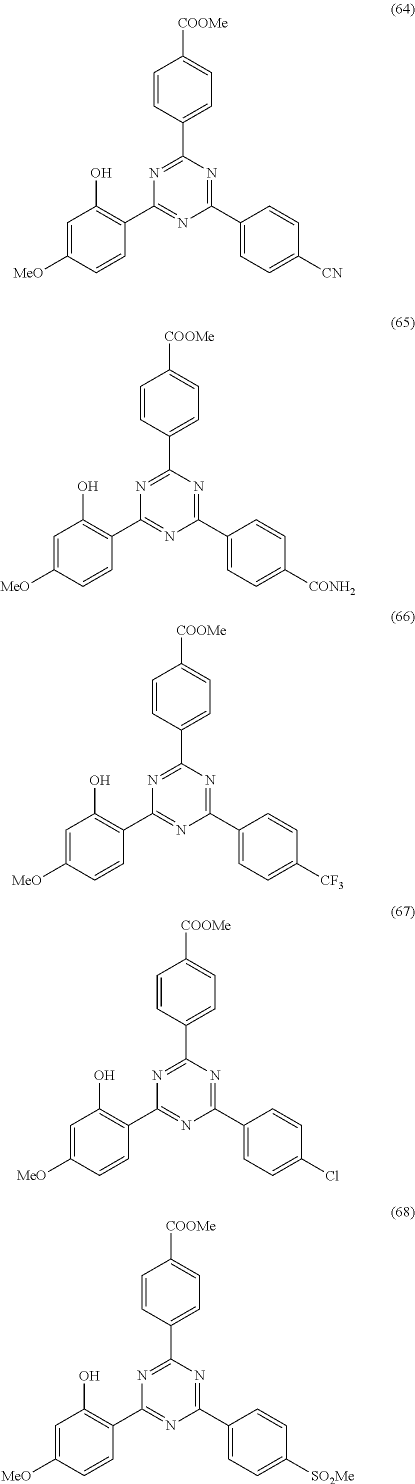

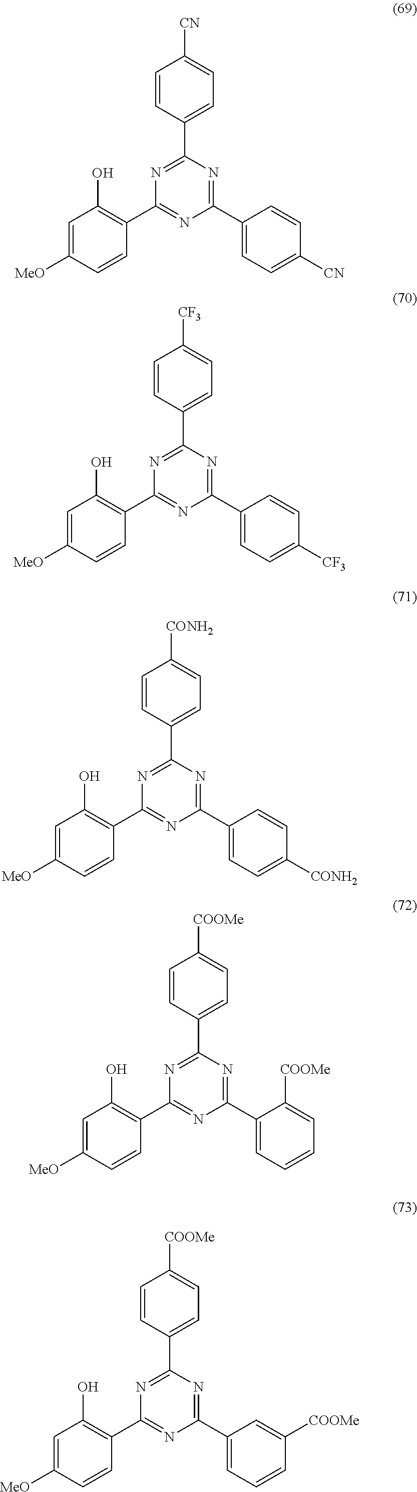

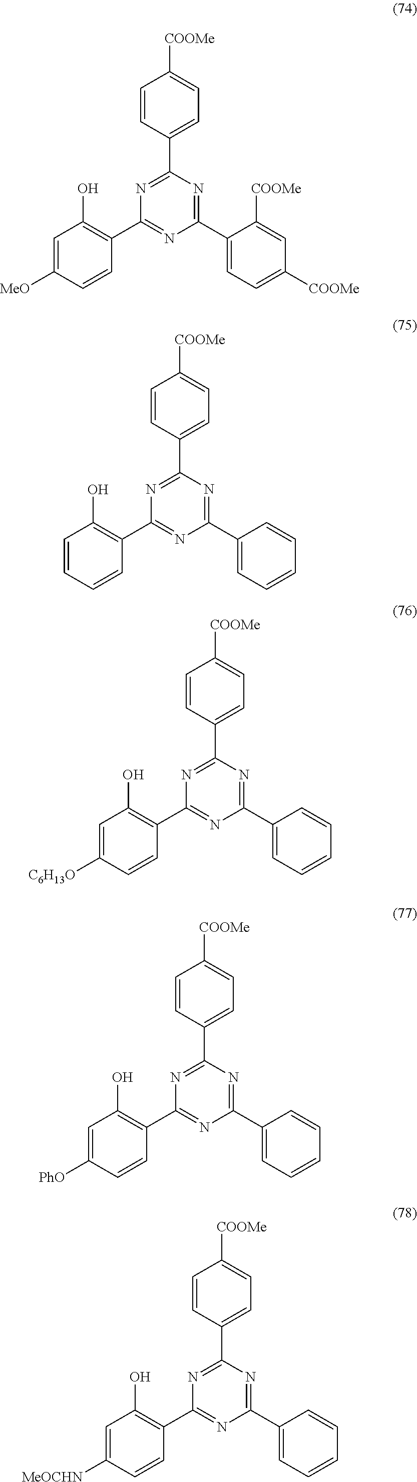

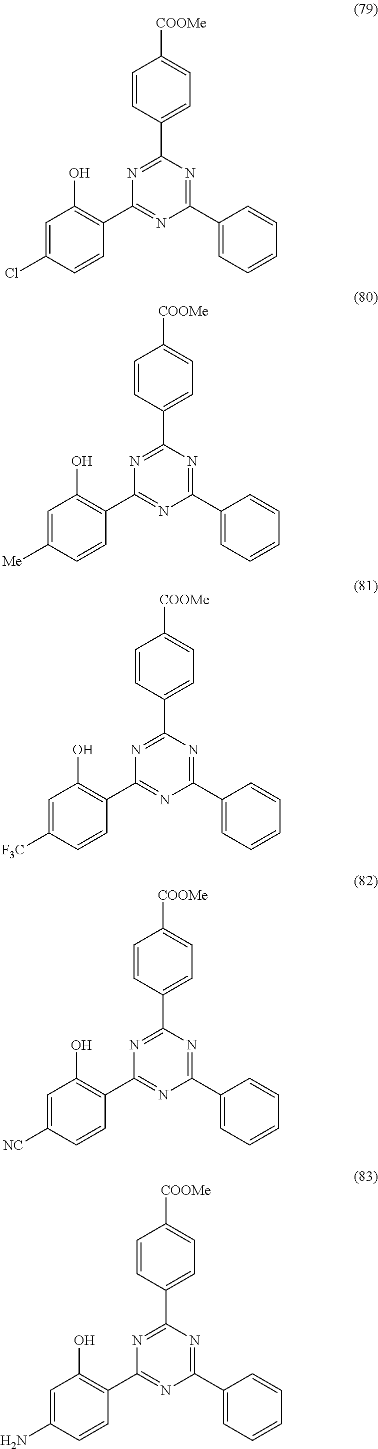

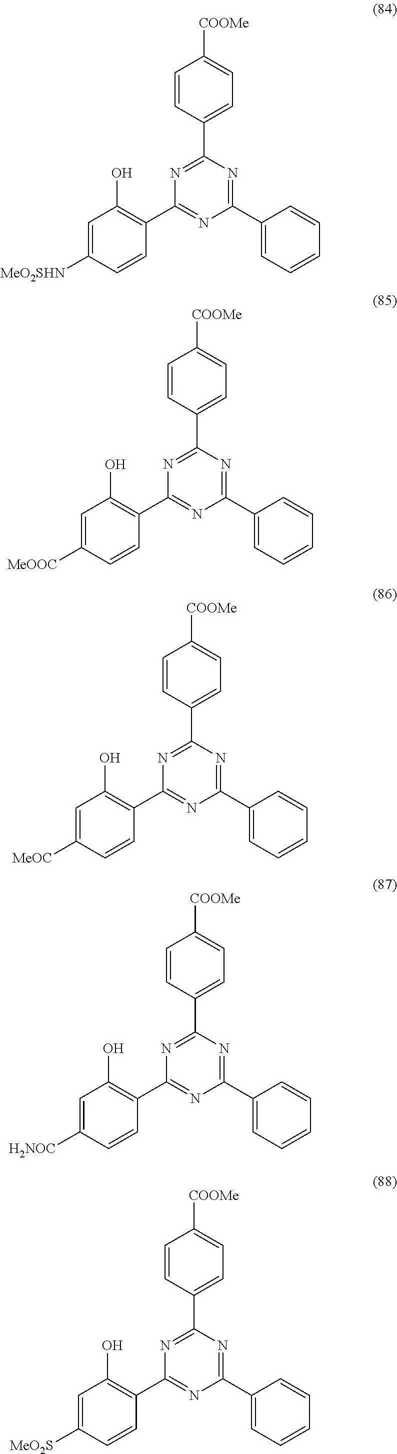

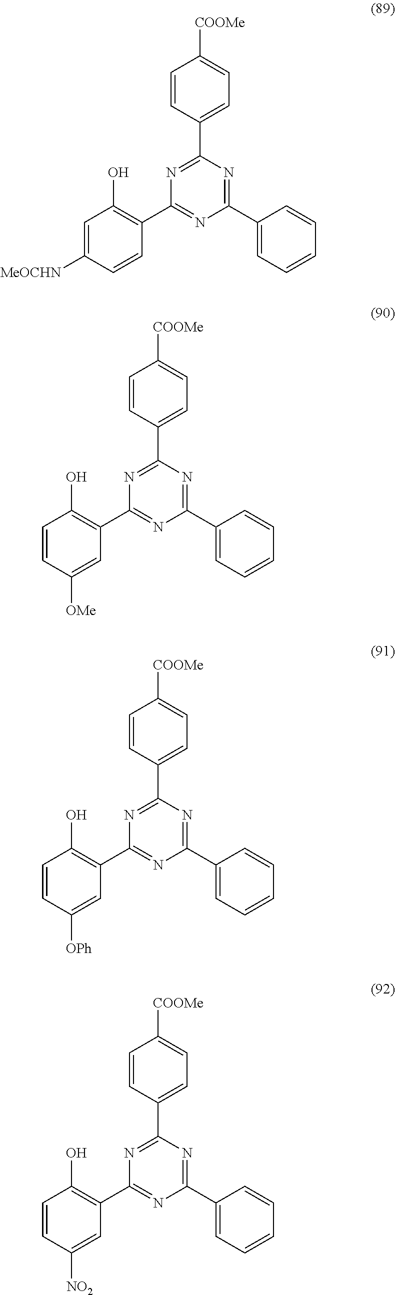

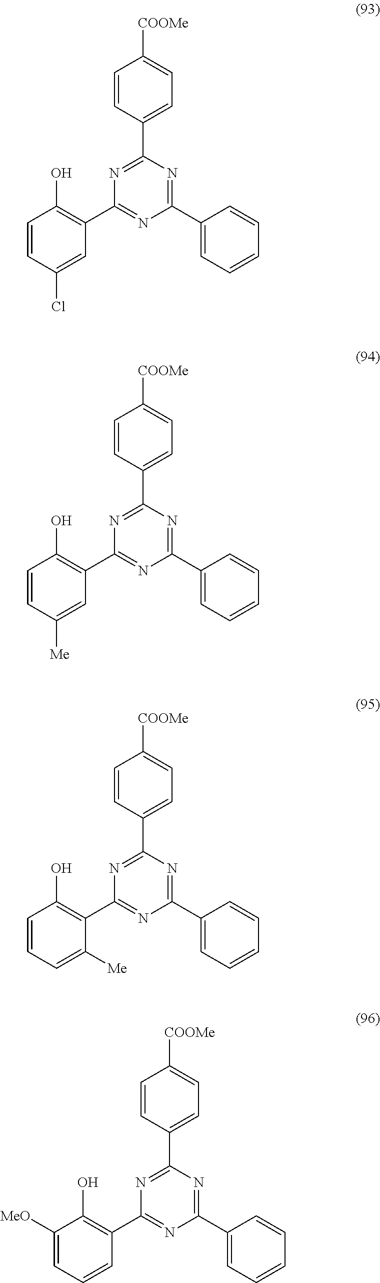

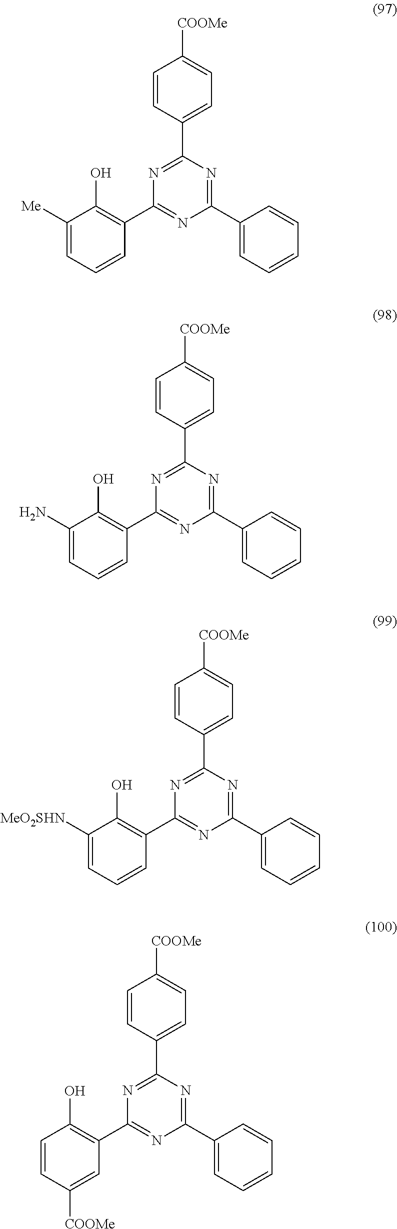

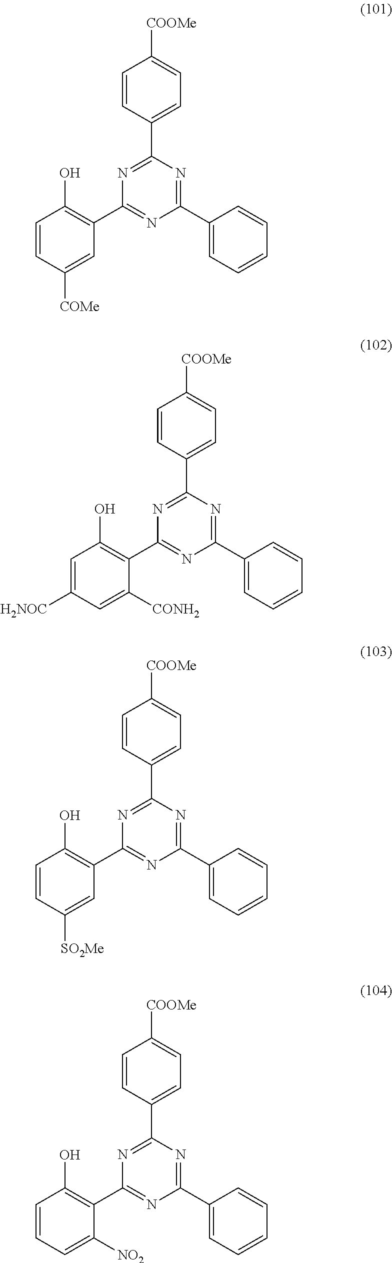

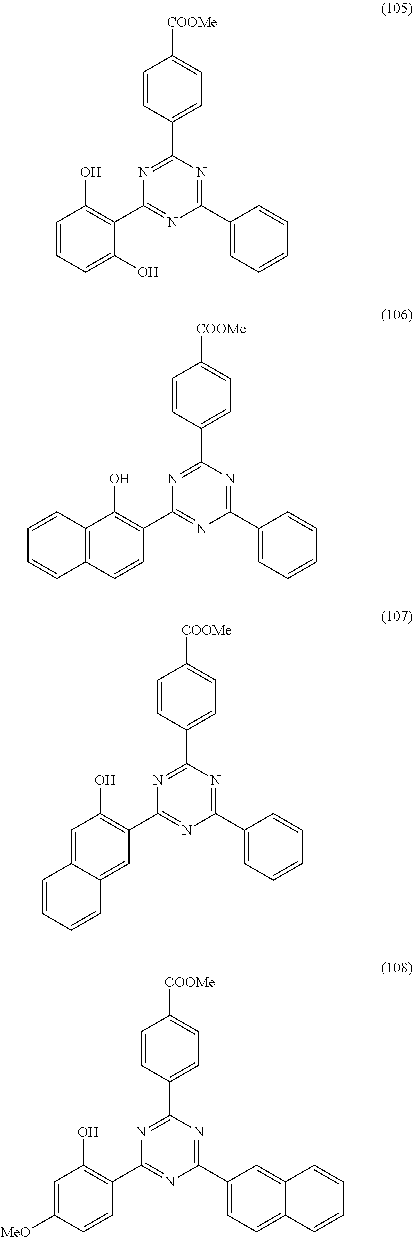

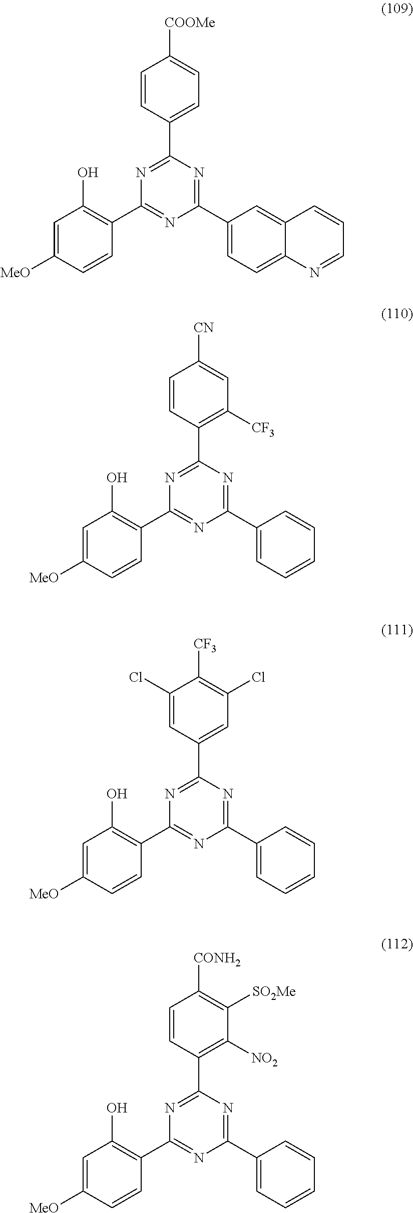

The compound represented by formula (1) may take a tautomer form depending on the structure and the environment. In the present invention, the compound is described by referring to one of representative forms, but a tautomer different from the compound described in the present invention is also included in the compound of the present invention.

The compound represented by formula (1) may contain an isotope (e.g., ²H, ³H, ¹³C, ¹⁵N, ¹⁷O, ¹⁸O).

The compound represented by formula (1) can be synthesized by an arbitrary method.

For example, the compound can be synthesized by referring to known patent documents or non-patent documents such as JP-A-7-188190, JP-A-11-315072, JP-A-2001-220385, and Senryo to Yakuhin (Dyes and Chemicals), Vol. 40, No. 12, pp. 325-339 (1995). Specifically, Compound (16) can be synthesized by reacting 4-methoxysalicylamide with 3,5-bis(trifluoromethyl)benzoyl chloride and benzamidine hydrochloride.

In the polycarbonate resin composition of the present invention, only one kind of the compound represented by formula (1) may be used, or two or more kinds thereof may be used in combination.

The compound above for use in the present invention is particularly suitable to stabilize an organic material against damages due to light/oxygen or heat. Above all, the compound represented by formula (1) can be suitably used as a light stabilizer, particularly as an ultraviolet absorber.

The compound represented by formula (1) contains a substituent having a positive Hammett's σp value at a specific position and therefore, LUMO is stabilized by an electron-withdrawing group, so that the compound can exhibit a short excitation life and have excellent light resistance. Also, with respect to use as an ultraviolet absorber, in the case of using a known triazine-based compound, the compound decomposes in use for a long time and causes an adverse effect such as yellowing.

In contrast, the compound represented by formula (1) has excellent light resistance and therefore, produces an effect that even when used for a long time, the compound is not decomposed and causes no yellowing.

The maximum absorption wavelength of the compound represented by formula (1) is not particularly limited but is preferably from 250 to 400 nm, more preferably from 280 to 380 nm, and the half-value width is preferably from 20 to 100 nm, more preferably from 40 to 80 nm.

The maximum absorption wavelength and half-value width specified in the present invention can be easily measured by one skilled in the art. The measuring method is described, for example, in Dai 4-han Jikken Kagaku Koza 7, Bunko II (4th ed., Experimental Chemistry Course 7, Spectroscopy II)”, pp. 180-186, edited by Chemical Society of Japan, Maruzen (1992). Specifically, these are determined by dissolving a sample in an appropriate solvent and measuring the spectrum in a spectrophotometer by using two quartz-made or glass-made cells for the sample and for control. It is required for the solvent used here to dissolve the sample, have no absorption in the measurement wavelength range, cause little interaction with the solute molecule, and be relatively low in the volatility. An arbitrary solvent may be used as long as the conditions above are satisfied. In the present invention, the measurement is performed using ethyl acetate (EtOAc) as the solvent.

The maximum absorption wavelength and the half-value width of the compound for use in the present invention are a value determined using a quartz cell having an optical path length of 10 mm after preparing a solution in a concentration of about 5×10⁻⁵ mol·dm⁻³ by using ethyl acetate as the solvent.

The spectral half-value width is described, for example, in Dai 4-han Jikken Kagaku Koza 3, Kihon Sosa III (4th ed., Experimental Chemistry Course 3, Basic Operation III)”, page 154, edited by Chemical Society of Japan, Maruzen (1991). Incidentally, the half-vale width is described in the literature above by labeling the abscissa with a wavenumber scale, but the half-value width used in the present invention is a value when the axis is marked with a wavelength scale, and the unit of the half-width value width is nm. Specifically, the half-value width indicates the width of the absorption band at an absorbance of ½ of that at the maximum absorption wavelength and is used as an indicator of the absorption spectral shape. A spectrum with a small half-value width is a sharp spectrum, and a spectrum with a large half-value width is a broad spectrum. The ultraviolet absorbing compound giving a broad spectrum has absorption also in a broad region on the longer wavelength side than the maximum absorption wavelength and therefore, in order to effectively block the light in the long-wavelength ultraviolet range with no yellow tinting, an ultraviolet absorbing compound giving a spectrum with a small half-value width is preferred.

As described in Sumio Tokita, Kagaku Seminar 9, Color Chemistry (Chemistry Seminar 9, Color Chemistry), pp. 154-155, Maruzen (1982), the absorption intensity of light, namely, the oscillator intensity, is proportional to the integral of the molar extinction coefficient and when the absorption spectrum has good symmetry, the oscillator intensity is proportional to the product of the absorbance at the maximum absorption wavelength and the half-value width (here, the half-value width is a value when the axis is marked with a wavelength scale). This indicates that as long as the value of transition moment is the same, a compound giving a spectrum with a small half-value width exhibits large absorbance at the maximum absorption wavelength. Use of such an ultraviolet absorbing compound is advantageous in that light in the region around the maximum absorption wavelength can be effectively blocked only by its use in a small amount, but absorbance at the wavelength a little distance away from the maximum absorption wavelength rapidly decreases, and it is impossible to block the light over a wide region.

The molar extinction coefficient at the maximum absorption wavelength of the compound represented by formula (1) is preferably 20,000 or more, more preferably 30,000 or more, still more preferably 50,000 or more. With a molecular extinction coefficient of 20,000 or more, the absorption efficiency per mass of the compound represented by formula (1) is sufficiently high and the amount of the compound represented by formula (1) used for completely absorbing the light in the ultraviolet region can be reduced. This is also preferred from the standpoint of preventing irritation to skin or accumulation in vivo and hardly causing bleed-out. Incidentally, the molar extinction coefficient is a molar extinction coefficient based on the definition described, for example, in Shin-han Jikken Kagaku Koza 9, Bunseki Kagaku [II] (New Edition, Experimental Chemistry Course 9, Analytical Chemistry [II]”, page 244, edited by Chemical Society of Japan, Maruzen (1977) and can be determined together when determining the above-described maximum absorption wavelength and half-value width.

The polycarbonate resin composition of the present invention can contain the compound represented by formula (1) in an arbitrary amount required to impart the desired performance. The amount varies depending on the compound or resin used, but an appropriate content can be specified. The content in the resin composition is preferably from more than 0 mass % to 20 mass %, more preferably from more than 0 mass % to 10 mass %, still more preferably from 0.05 to 5 mass %. The content in the range above is preferred because a sufficiently high effect of blocking ultraviolet light is obtained and the bleed-out can be suppressed.

The polycarbonate resin composition may contain, as the ultraviolet absorber, two or more kinds of compounds represented by formula (1) differing in the structure. Also, a compound represented by formula (1) and one or more kinds of ultraviolet absorbers having a structure other than the formula above may be used in combination. When two kinds (preferably three kinds) of ultraviolet absorbers differing in the basic framework structure are used, ultraviolet light in a wide wavelength region can be absorbed. Also, use of two or more kinds of ultraviolet absorbers produces an action of stabilizing the dispersion state of the ultraviolet absorbers. As for the ultraviolet absorber having a structure other than formula (1), any ultraviolet absorber may be used, and examples thereof include triazine-based, benzotriazole-based, benzophenone-based, merocyanine-based, cyanine-based, dibenzoylmethane-based, cinnamic acid-based, cyanoacrylate-based and benzoic ester-based compounds. Other examples include the ultraviolet absorbers described in Fine Chemical, pp. 28-38 (May 2004), Kobunshi-yo Kinousei Tenkabutsu no Shin Tenkai (New Development of Functional Additives for Polymers), pp. 96-140, issued by Toray Research Center Inc., Technical Survey Dept. (Toray Research Center Inc., 1999), and Yasuichi Okatsu (supervisor), Kobunshi Tenkazai no Kaihatsu to Kannkyo Taisaku (Development of Polymer Additives and Environmental Measures), pp. 54-64, CMC Publishing (2003).

The ultraviolet absorber having a structure other than formula (1) is preferably a benzotriazole-based compound, a benzophenone-based compound, a salicylic acid-based compound, a benzoxazinone-based compound, a cyanoacrylate-based compound, a benzoxazole-based compound, a merocyanine-based compound, or a triazine-based compound, more preferably a benzoxazinone-based compound, a benzotriazole-based compound, a benzophenone-based compound, or a triazine-based compound, still more preferably a benzoxazinone-based compound. The ultraviolet absorbers having a structure other than formula (1) are described in detail in Japanese Patent Application No. 2008-273950, paragraphs [0117] to [0121], and the materials described in this patent publication can be applied also in the present invention.

As described above, the polycarbonate resin composition of the present invention preferably contains a compound represented by formula (1) and a benzoxazinone-based compound in combination. The compound represented by formula (1) has excellent light resistance even in the long-wavelength region and therefore, produces an effect of preventing deterioration of benzoxazinone that can block the light to a longer wavelength region, and thanks to use together with a benzoxazinone-based compound, the blocking effect to a longer wavelength region can be advantageously maintained for a long period of time.

The polycarbonate resin composition of the present invention can practically exhibit a sufficient ultraviolet-blocking effect by using only the ultraviolet absorber represented by formula (1) but, if the requirement is more strict, a white pigment having a strong hiding power, such as titanium oxide, may be used in combination. Also, when the appearance or color tone becomes a problem or if desired, a slight amount (0.05 mass % or less) of a colorant may be used in combination. In applications where transparency or whiteness is important, a fluorescent brightener may be used in combination. Examples of the fluorescent brightener include commercial products and the compound of formula [1] and specific Compounds 1 to 35 described in JP-A-2002-53824.

The polycarbonate resin composition of the present invention contains a compound represented by formula (1) and therefore, has excellent light resistance (fastness to ultraviolet light), and the ultraviolet absorber does not cause precipitation or bleed-out due to long-term use.

The resin component such as polycarbonate resin contained in the polycarbonate resin composition of the present invention is described below.

The polycarbonate is a polymer compound being obtained, for example, by the transesterification of a di-substituted carbonate and a diol or the reaction of phosgene and a diol and containing a carbonate-type structure as a structural unit in the main chain. Examples of the polycarbonate include a linear polycarbonate, a branched polycarbonate, and a composite polymer containing a linear polycarbonate and a branched polycarbonate. The linear polycarbonate or branched polycarbonate can be obtained by copolymerizing a diol and a di-substituted carbonate or phosgene in the presence or absence of a branching agent, if desired, by further using a terminal stopper.

Examples of the diol include dihydroxydiarylalkanes such as bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 2,2-bis(4-hydroxyphenyl)propane [alias: bisphenol A], 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane and 1,10-bis(4-hydroxyphenyl)decane; dihydroxydiarylcycloalkanes such as 1,1-bis(4-hydroxyphenyl)cyclohexane, 1,1-bis(3,5-dichloro-4-hydroxyphenyl)cyclohexane, 1,1-bis(4-hydroxyphenyl)-3,3,5-trimethylcyclohexane, 2,2-bis(4-hydroxyphenyl)-1,1,1,3,3,3-hexafluoropropane and 1,1-bis(4-hydroxyphenyl)cyclodecane; dihydroxydiarylsulfones such as bis(4-hydroxyphenyl)sulfone, bis(3,5-dimethyl-4-hydroxyphenyl)sulfone and bis(3-chloro-4-hydroxyphenyl)sulfone; dihydroxydiaryl ethers such as bis(4-hydroxyphenyl)ether and bis(3,5-dimethyl-4-hydroxyphenyl)ether; dihydroxydiaryl ketones such as 4,4′-dihydroxybenzophenone and 3,3′,5,5′-tetramethyl-4,4′-dihydroxybenzophenone; dihydroxydiarylsulfides such as bis(4-hydroxyphenyl)sulfide, bis(3-methyl-4-hydroxyphenyl)sulfide and bis(3,5-dimethyl-4-hydroxyphenyl)sulfide; dihydroxydiarylsulfoxides such as bis(4-hydroxyphenyl)sulfoxide; dihydroxydiphenyls such as 4,4′-dihydroxydiphenyl; and dihydroxyarylfluorenes such as 9,9-bis(4-hydroxyphenyl)fluorene. In addition to the above-described diols, ethylene glycol, 1,3-propanediol, 1,4-butanediol, 1,6-hexanediol, 1,4-cyclohexanediol, 4,4′-dihydroxyethoxy-phenylmethane; dihydroxybenzenes such as hydroquinone, resorcinol and methylhydroquinone; or dihydroxynaphthalenes such as 1,5-dihydroxynaphthalene and 2,6-dihydroxynaphthalene, may also be contained. One of these diols and the like may be used, or two or more thereof may be used in combination. Among these, 2,2-bis(4-hydroxyphenyl)propane is representative.

Examples of the di-substituted carbonate compound include a diaryl carbonate such as diphenyl carbonate, and a dialkyl carbonate such as dimethyl carbonate and diethyl carbonate. One of these di-substituted carbonate compounds may be used alone, or two or more thereof may be used in combination.

The branching agent is not particularly limited, and a compound having three or more functional groups can be used. Specific examples of the branching agent include phloroglycine, mellitic acid, trimellitic acid, trimellitic acid chloride, trimellitic anhydride, protocatechuic acid, pyromellitic acid, pyromellitic dianhydride, α-resorcylic acid, β-resorcylic acid, resorcin aldehyde, trimethyl chloride, isatin-bis(o-cresol), trimethyl trichloride, 4-chloroformylphthalic anhydride, benzophenonetetracarboxylic acid, 2,4,4′-trihydroxybenzophenone, 2,2′,4,4′-tetrahydroxybenzophenone, 2,4,4′-trihydroxyphenyl ether, 2,2′,4,4′-tetrahydroxyphenyl ether, 2,4,4′-trihydroxydiphenyl-2-propane, 2,2′-bis(2,4-dihydroxy)propane, 2,2′,4,4′-tetrahydroxydiphenylmethane, 2,4,4′-trihydroxydiphenylmethane, 1-[α-methyl-α-(4′-dihydroxyphenyl)ethyl]-3-[α′,α′-bis(4″-hydroxyphenyl)ethyl]benzene, 1-[α-methyl-α-(4′-dihydroxyphenyl)ethyl]-4-[α′,α′-bis(4″-hydroxyphenyl)ethyl]benzene, α,α′,α″-tris(4-hydroxyphenyl)-1,3,5-triisopropylbenzene, 2,6-bis(2-hydroxy-5′-methylbenzyl)-4-methylphenol, 4,6-dimethyl-2,4,6-tris-(4′-hydroxyphenyl)-2-heptene, 4,6-dimethyl-2,4,6-tris(4′-hydroxyphenyl)-2-heptane, 1,3,5-tris(4′-hydroxyphenyl)benzene, 1,1,1-tris(4-hydroxyphenyl)ethane, 2,2-bis[4,4-bis(4′-hydroxyphenyl)cyclohexyl]propane, 2,6-bis(2′-hydroxy-5′-isopropylbenzyl)-4-isopropylphenol, bis[2-hydroxy-3-(2′-hydroxy-5′-methylbenzyl)-5-methylphenyl]methane, bis[2-hydroxy-3-(2′-hydroxy-5′-isopropylbenzyl)-5-methylphenyl]methane, tetrakis(4-hydroxyphenyl)methane, tris(4-hydroxyphenyl)phenylmethane, 2′,4′,7-trihydroxyflavan, 2,4,4-trimethyl-2′,4′,7-trihydroxyflavan, 1,3-bis-(2′,4′-dihydroxyphenylisopropyl)benzene and tris(4′-hydroxyphenyl)-amyl-s-triazine. One of these branching agents may be used alone, or two or more thereof may be used in combination.

As for the terminal stopper, a monovalent phenol can be used, and the structure thereof is not particularly limited. For example, p-tert-butylphenol, p-tert-octylphenol, p-cumylphenol, p-tert-amylphenol, p-nonylphenol, p-cresol, 2,4,6-tribromophenol, p-bromophenol, 4-hydroxybenzophenone or phenol is used as the monovalent phenol. One of these terminal stoppers may be used alone, or two or more thereof may be used in combination.

As for the polymerization method, an interface method or a transesterification method is used. For example, in the case of polymerizing a diol and phosgene by the interface method, a branching agent or a terminal stopper may be reacted in the presence of phosgene, or after obtaining a polycarbonate oligomer by the reaction of a diol and phosgene, a branching agent or a terminal stopper may be reacted therewith in the absence of phosgene. Also, in the case of the transesterification method, a branching agent or a terminal stopper is added in the transesterification of a diol and a di-substituted carbonate compound, whereby a branched polycarbonate resin can be obtained.

The linear polycarbonate is usually obtained by polymerizing a diol and phosgene or a di-substituted carbonate compound, if desired, in the presence of a terminal stopper. That is, the process is the same as that for the branched polycarbonate resin except for using no branching agent.

Among the polycarbonates obtained by polymerizing a diol and phosgene or a di-substituted carbonate compound, in view of balance between the mechanical strength and the shapability, a polycarbonate obtained by reacting 2,2-bis(4-hydroxyphenyl)propane and diphenyl carbonate, a polycarbonate obtained by reacting 2,2-bis(4-hydroxyphenyl)propane and dimethyl carbonate, a polycarbonate obtained by reacting 2,2-bis(4-hydroxyphenyl)propane and diethyl carbonate, a polycarbonate obtained by reacting bis(4-hydroxyphenyl)methane and diphenyl carbonate, and a polycarbonate obtained by reacting bis(4-hydroxyphenyl)phenylmethane and diphenyl carbonate are preferred.

Furthermore, in the present invention, a polycarbonate-polyorganosiloxane copolymer containing a polycarbonate structural unit and a polyorganosiloxane structural unit may be used as the polycarbonate. Also, an aromatic or aliphatic dibasic acid such as terephthalic acid, isophthalic acid, pimelic acid, suberic acid, azelaic acid, sebacic acid, decanedicarboxylic acid and adipic acid, or an ester thereof, which are an acid component, may be contained as a copolymerization component. In this case, a carboxylic acid ester structure is introduced into a part of the main chain in addition to a carbonate-type structure.

In the present invention, one of polycarbonates obtained using the above-described diol and di-substituted carbonate or phosgene or, if desired, further using other components may be used, or two or more thereof may be used in combination.

The viscosity average molecular weight of the polycarbonate is preferably from 10,000 to 50,000, more preferably from 13,000 to 40,000. With a viscosity average molecular weight in this range, a tough molded article is obtained and a high molding temperature is not required. The viscosity average molecular weight of the polycarbonate can be determined by the conversion from the specific viscosity at 20° C. of a solution obtained by dissolving the polycarbonate resin in methylene chloride.

In the polycarbonate resin composition of the present invention, the content ratio of the compound represented by formula (1) is preferably from 0.05 to 3 parts by mass, more preferably from 0.05 to 1 part by mass, per 100 parts by mass of the polycarbonate.

The polycarbonate resin composition of the present invention may contain other resin components in combination with the polycarbonate resin. The resin component which can be used in combination may be either a natural polymer or a synthetic polymer. Examples thereof include a polyolefin such as polyethylene, polypropylene, polyisobutylene, poly(1-butene), poly-4-methylpentene, polyvinylcyclohexane, polystyrene, poly(p-methylstyrene), poly(α-methylstyrene), polyisoprene, polybutadiene, polycyclopentene and polynorbornene; a copolymer of a vinyl monomer, such as ethylene/propylene copolymer, ethylene/methylpentene copolymer, ethylene/heptene copolymer, ethylene/vinylcyclohexane copolymer, ethylene/cycloolefin copolymer (for example, a cycloolefin copolymer (COC: Cyclo-Olefin Copolymer) such as ethylene/norbornene), propylene/butadiene copolymer, isobutylene/isoprene copolymer, ethylene/vinylcylcohexene copolymer, ethylene/alkyl acrylate copolymer and ethylene/alkyl methacrylate copolymer; an acrylic polymer such as polymethacrylate, polyacrylate, polyacrylamide and polyacrylonitrile; a polyvinyl chloride; a polyvinylidene chloride; a polyvinyl fluoride; a polyvinylidene fluoride; a vinyl chloride/vinyl acetate copolymer; a polyether such as polyalkylene glycol, polyethylene oxide and polypropylene oxide; a polyacetal such as polyoxymethylene; a polyamide; a polyimide; a polyurethane; a polyurea; a polyester such as polyethylene terephthalate and polyethylene naphthalate; a polyketone; a polysulfone polyether ketone; a phenol resin; a melamine resin; a cellulose ester such as diacetylcellulose, triacetylcellulose (TAC), propionylcellulose, butyrylcellulose, acetylpropionylcellulose and nitrocellulose; a polysiloxane; and a natural polymer such as cellulose, rubber and gelatin.

The resin component which can be used in combination is preferably a synthetic polymer, more preferably a polyolefin, an acrylic polymer, a polyester or a cellulose ester, still more preferably polyethylene, polypropylene, poly(4-methylpentene), polymethyl methacrylate, polyethylene terephthalate, polyethylene naphthalate, polybutylene terephthalate or triacetylcellulose. The resin component which can be used in combination is preferably a thermoplastic resin.

The polycarbonate resin composition of the present invention may appropriately contain, if desired, an arbitrary additive such as antioxidant, light stabilizer, process stabilizer, anti-aging agent and compatibilizer.

The polycarbonate resin composition of the present invention preferably further contains a phosphorus-based stabilizer as the antioxidant, because thermal stability can be improved. Examples of the phosphorus-based stabilizer include phosphorous acid, phosphoric acid, a phosphorous acid ester and a phosphoric acid ester. Among these, a phosphorous acid ester such as phosphite and phosphonite contains a trivalent phosphorus to readily exert a discoloration-preventing effect and therefore, is preferred.

Examples of the phosphite include triphenyl phosphite, tris(nonylphenyl)phosphite, dilauryl hydrogenphosphate, triethyl phosphite, tridecyl phosphite, tris(2-ethylhexyl)phosphite, tris(tridecyl)phosphite, tristearyl phosphite, diphenyl monodecyl phosphite, monophenyl didecyl phosphite, diphenyl mono(tridecyl)phosphite, tetraphenyl dipropylene glycol diphosphite, tetraphenyl tetra(tridecyl)pentaerythritol tetraphosphite, hydrogenated bisphenol A phenol phosphite polymer, diphenyl hydrogenphosphate, 4,4′-butylidene-bis(3-methyl-6-tert-butylphenyl-di(tridecyl)phosphite, tetra(tridecyl)-4,4′-isopropylidene diphenyl diphosphite, bis(tridecyl)pentaerythritol diphosphite, bis(nonylphenyl)pentaerythritol diphosphite, dilauryl pentaerythritol diphosphite, distearyl pentaerythritol diphosphite, tris(4-tert-butylphenyl)phosphite, tris(2,4-di-tert-butylphenyl)phosphite, a hydrogenated bisphenol A pentaerythritol phosphite polymer, bis(2,4-di-tert-butylphenyl)pentaerythritol diphosphite, bis(2,6-di-tert-butyl-4-methylphenyl)pentaerythritol diphosphite, 2,2′-methylenebis(4,6-di-tert-butylphenyl)octylphosphite and bis(2,4-dicumylphenyl)pentaerythritol diphosphite.

Examples of the phosphonite include tetrakis(2,4-di-iso-propylphenyl)-4,4′-biphenylene diphosphonite, tetrakis(2,4-di-n-butylphenyl)-4,4′-biphenylene diphosphonite, tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-iso-propylphenyl)-4,4′-biphenylene diphosphonite, tetrakis(2,6-di-n-butylphenyl)-4,4′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite, and tetrakis(2,6-di-tert-butylphenyl)-3,3′-biphenylene diphosphonite.

Examples of the acid phosphate include methyl acid phosphate, ethyl acid phosphate, propyl acid phosphate, isopropyl acid phosphate, butyl acid phosphate, butoxyethyl acid phosphate, octyl acid phosphate, 2-ethylhexyl acid phosphate, decyl acid phosphate, lauryl acid phosphate, stearyl acid phosphate, oleyl acid phosphate, behenyl acid phosphate, phenyl acid phosphate, nonylphenyl acid phosphate, cyclohexyl acid phosphate, phenoxyethyl acid phosphate, alkoxypolyethylene glycol acid phosphate, bisphenol A acid phosphate, dimethyl acid phosphate, diethyl acid phosphate, dipropyl acid phosphate, diisopropyl acid phosphate, dibutyl acid phosphate, dioctyl acid phosphate, di-2-ethylhexyl acid phosphate, dioctyl acid phosphate, dilauryl acid phosphate, distearyl acid phosphate, diphenyl acid phosphate, and bisnonylphenyl acid phosphate.

The phosphorus-based stabilizer for use in the present invention may be contained by mixing two or more kinds thereof, but the total content ratio of phosphorus-based stabilizers is preferably from 0.0005 to 0.3 parts by mass, more preferably from 0.001 to 0.1 parts by mass, per 100 parts by mass of the polycarbonate resin composition. Within this range, the stabilizer exerts a sufficient effect, and reduction in the molecular weight or deterioration of the color hue is hardly caused during shaping.

In the present invention, it is particularly preferred that the compound represented by formula (1) accounts for 0.05 to 3 parts by mass and the phosphorus-based stabilizer accounts for 0.0005 to 0.3 parts by mass, per 100 parts by mass of the polycarbonate resin composition.

The polycarbonate resin composition of the present invention preferably further contains a hindered phenol-based stabilizer as the antioxidant, because the compound represented by formula (1) can be stabilized and in turn, the light stability of the polycarbonate resin composition is increased.

Examples of the hindered phenol-based stabilizer include a compound having at least one substituent (for example, an alkyl group, an alkenyl group, an alkynyl group, an aryl group, a heterocyclic group, an alkoxy group, an aryloxy group or a substituted amino group) except for hydrogen atom, at the ortho-position of a phenolic hydroxyl group.

The hindered phenol-based stabilizer may be a compound known as an antioxidant and available on the market, and examples thereof include 2,6-di-tert-butyl-4-methylphenol and the antioxidants produced by Ciba Specialty Chemicals.

The hindered phenol-based stabilizers for use in the present invention may be contained by mixing two or more kinds thereof, but the total content ratio of hindered phenol-based stabilizers is preferably from 0.0001 to 1 part by mass, more preferably from 0.001 to 0.1 parts by mass, per 100 parts by mass of the polycarbonate resin composition.

The method for mixing the compound represented by formula (1) and a resin component such as polycarbonate to prepare a polycarbonate resin composition of the present invention is not particularly limited.

In the case where the compound represented by formula (1) has compatibility with the resin component such as polycarbonate, the compound represented by formula (1) can be directly added to the resin component such as polycarbonate. Other examples include a method of melt-kneading the mixture by a melt-kneader as represented by vented twin-screw extruder and pelletizing it by a device such as pelletizer.

The compound represented by formula (1) may be dissolved in an auxiliary solvent having compatibility with the resin component such as polycarbonate, and the solution may be added to the resin component such as polycarbonate. Also, the compound represented by formula (1) may be dispersed in a high boiling-point organic solvent or a polymer, and the dispersion may be added to the resin component such as polycarbonate.

The timing for the addition and mixing may be before or after the resin component such as polycarbonate is formed by polymerization.

The polycarbonate resin composition of the present invention may be a composition formed by dissolving the polycarbonate resin in an arbitrary solvent.

Examples of the high boiling-point organic solvent include a phosphoric acid ester, a phosphonic acid ester, a benzoic acid ester, a phthalic acid ester, a fatty acid ester, a carbonate, an amide, an ether, a halogenated hydrocarbon, an alcohol and a paraffin. Among these, a phosphoric acid ester, a phosphonic acid ester, a phthalic acid ester, a benzoic acid ester and a fatty acid ester are preferred.

As for the method to prepare the polycarbonate resin composition of the present invention, JP-A-58-209735, JP-A-63-264748, JP-A-4-191851, JP-A-8-272058, and British Patent 2016017A can be referred to.

The polycarbonate resin composition of the present invention is usable in all applications using a synthetic resin but is suitably usable in particular for the application that is likely to be exposed to sunlight or ultraviolet ray-containing light. Specific examples thereof include a glass alternative and a surface-coating material therefor; a coating material for window glass, lighting glass and light source-protecting glass in house, facility, transport vehicle and the like; a window film for house, facility, transport vehicle and the like; an interior or exterior material and an interior or exterior paint for house, facility, transport vehicle and the like, and a coating formed by the paint; an alkyd resin lacquer paint and a coating formed by the paint; an acrylic lacquer paint and a coating formed by the paint; a member for ultraviolet-emitting light sources such as fluorescent lamp and mercury lamp; a material for precision machines and electric/electronic devices; a material for blocking electromagnetic and other waves emitted from various displays; a container or packaging material for food, chemicals, drugs and the like; a material for special packages such as bottle, box, blister and cup; a discoloration inhibitor for compact disk coat, agricultural and industrial sheet or film, printed matter, dyed matter, dye/pigment and the like; a protective film for polymer supports (such as plastic-made parts, e.g., mechanical or automotive parts); an overcoat for printed matters; an inkjet medium coat; a laminate with matte finish; an optical light film; a safety glass/front glass intermediate layer; an electrochromic/photochromic application; an over-lamination film; a solar heat-controlling film; a cosmetic material such as anti-sunburn cream, shampoo, rinse and hair dressing; an apparel fiber product such as sport wear, stockings and cap, and the fiber; a home interior product such as curtain, carpet and wall paper; a medical device such as plastic lens, contact lens and artificial eye; an optical material such as optical filter, backlight display film, prism, mirror and photographic material; a mold film; a transfer-type sticker; an anti-graffiti film; a stationery product such as tape and ink; and an indicator board or device and the surface-coating material therefor.

The molded article of the present invention is described below.

The molded article of the present invention can be formed from the polycarbonate resin composition of the present invention.

The shape of the molded article of the present invention formed from the above-described polycarbonate resin composition may be any form of flat film, powder, spherical particle, crushed particle, continuous block, fiber, tube, hollow yarn, granule, plate and porous solid.

The polycarbonate resin composition of the present invention contains a polycarbonate resin and therefore, can be transparent and in this case, the composition can be shaped as an ultraviolet absorbing filter or an ultraviolet absorbing film.

At this time, the polycarbonate resin composition of the present invention may contain other transparent resins. Examples of the other transparent resin include a cellulose ester such as diacetylcellulose, triacetylcellulose (TAC), propionylcellulose, butyrylcellulose, acetylpropionylcellulose and nitrocellulose; a polyamide; a polyester such as polyethylene terephthalate, polyethylene naphthalate, polybutylene terephthalate, poly-1,4-cyclohexanedimethylene terephthalate, polyethylene-1,2-diphenoxyethane-4,4′-dicarboxylate and polybutylene terephthalate; a polystyrene such as syndiotactic polystyrene; a polyolefin such as polyethylene, polypropylene and polymethylpentene; a polymethyl methacrylate; a syndiotactic polystyrene; a polysulfone; a polyether sulfone; a polyether ketone; a polyether imide; and a polyoxyethylene.

The molded article of the present invention obtained from the above-described polycarbonate resin composition can be used as a transparent support, and the transmittance of the transparent support is preferably 80% or more, more preferably 86% or more.

The molded article of the present invention is formed by shaping the polycarbonate resin composition and has an excellent long-wavelength ultraviolet absorbing ability, so that the molded article can be used as an ultraviolet absorbing filter or container or can protect a compound sensitive to ultraviolet ray. For example, the molded article of the present invention can be obtained as a container or the like by shaping the polycarbonate resin composition by an arbitrary method such as extrusion molding or injection molding. Also, a solution of the polycarbonate resin composition of the present invention can be coated on a separately produced molded article and dried to obtain a molded article coated with an ultraviolet absorbing film composed of the polycarbonate resin composition.

### EXAMPLES

The present invention is described in greater detail below by referring to Examples, but the present invention is not limited thereto.

### 1. Synthesis Example

### Synthesis Example 1

### Preparation of Compound (1)

Acetonitrile (80 mL) and 36.4 g of DBU (diazabicycloundecene (1,8-diazabicyclo[5.4.0]undec-7-ene)) were added to 20.0 g of 4-methoxysalicylamide and dissolved. To this solution, 23.8 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 36.0 g of Synthetic Intermediate A (yield: 91%).

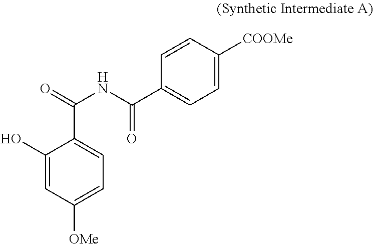

Acetonitrile (200 mL) and 8.9 g of sulfuric acid were added to 20.0 g of Synthetic Intermediate A, and the mixture was stirred at 90° C. for 4 hours. To the resulting reaction solution, 80 mL of triethylamine was added, and the mixture was cooled to room temperature. The obtained solid was filtered and washed with water to obtain 17.1 g of Synthetic Intermediate B (yield: 90%).

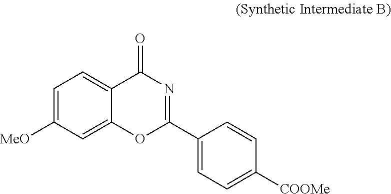

Methanol (100 mL) and 3.4 g of 28% sodium methoxide methanol solution were added to 2.8 g of benzamidine hydrochloride. To this solution, 5.0 g of Synthetic Intermediate B was added, and the mixture was stirred at 60° C. for 3 hours. The resulting reaction solution was cooled to room temperature, and 0.2 mL of hydrochloric acid was added thereto. The obtained solid was filtered and washed with water and methanol to obtain 6.1 g of Compound (1) (yield: 92%). MS: m/z 414 (M+).

¹H NMR (CDCl₃): δ6.55-6.56 (1H), δ6.62-6.64 (1H), δ7.58-7.65 (3H), δ8.22-8.24 (2H), δ8.62-8.65 (3H), δ8.71 (2H), δ13.39 (1H). λmax (maximum absorption wavelength)=341 nm (EtOAc).

### Synthesis Example 2

### Preparation of Compound (2)

Acetonitrile (80 mL) and 36.4 g of DBU were added to 20.0 g of 4-methoxysalicylamide and dissolved. To this solution, 19.8 g of 4-cyanobenzoyl chloride was added, and the mixture was stirred at room temperature for 24 hours. To the resulting reaction solution, 100 mL of water and 20 mL of 35% hydrochloric acid were added, and the obtained solid was filtered and washed with water to obtain 31.2 g of Synthetic Intermediate C (yield: 88%).

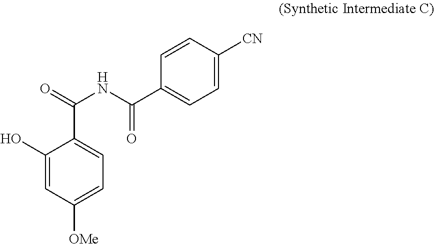

Acetonitrile (200 mL) and 9.9 g of sulfuric acid were added to 20.0 g of Synthetic Intermediate C, and the mixture was stirred at 90° C. for 4 hours. To the resulting reaction solution, 80 mL of triethylamine was added, and the mixture was cooled to room temperature. The obtained solid was filtered and washed with water to obtain 16.5 g of Synthetic Intermediate D (yield: 88%).

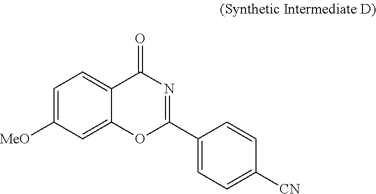

Methanol (100 mL) and 3.8 g of 28% sodium methoxide methanol solution were added to 3.1 g of benzamidine hydrochloride. To this solution, 5.0 g of Synthetic Intermediate D was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.3 g of Compound (2) (yield: 93%). MS: m/z 381 (M+).

¹H NMR (CDCl₃): δ6.55-6.56 (1H), δ6.62-6.64 (1H), δ7.58-7.62 (3H), δ7.65-7.69 (2H), δ8.60-8.62 (3H), δ8.76 (2H), δ13.26 (1H). λmax=342 nm (EtOAc).

### Synthesis Example 3

### Preparation of Compound (3)

Acetonitrile (80 mL) and 36.4 g of DBU were added to 20.0 g of 4-methoxysalicylamide and dissolved. To this solution, 24.9 g of 4-(trifluoromethyl)benzoyl chloride was added, and the mixture was stirred at room temperature for 24 hours. To the resulting reaction solution, 100 mL of water and 20 mL of 35% hydrochloric acid were added, and the obtained solid was filtered and washed with water to obtain 37.5 g of Synthetic Intermediate E (yield: 92%).

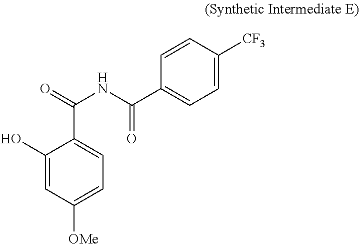

Acetonitrile (200 mL) and 8.8 g of sulfuric acid were added to 20.0 g of Synthetic Intermediate E, and the mixture was stirred at 90° C. for 4 hours. To the resulting reaction solution, 80 mL of triethylamine was added, and the mixture was cooled to room temperature. The obtained solid was filtered and washed with water to obtain 17.0 g of Synthetic Intermediate F (yield: 90%).

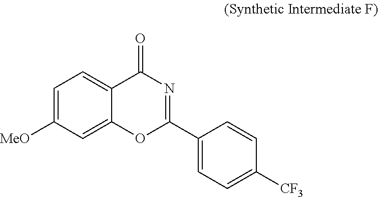

Methanol (100 mL) and 3.3 g of 28% sodium methoxide methanol solution were added to 2.8 g of benzamidine hydrochloride. To this solution, 5.0 g of Synthetic Intermediate F was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.0 g of Compound (3) (yield: 92%). MS: m/z 424 (M+).

¹H NMR (CDCl₃): δ6.56-6.57 (1H), δ6.62-6.65 (1H), δ7.58-7.66 (3H), δ7.82-7.85 (2H), δ8.62-8.64 (3H), δ8.76 (2H), δ13.35 (1H). λmax=342 nm (EtOAc).

### Synthesis Example 4

### Preparation of Compound (4)

Acetonitrile (80 mL) and 36.4 g of DBU were added to 20.0 g of 4-methoxysalicylamide and dissolved. To this solution, 20.9 g of 4-chlorobenzoyl chloride was added, and the mixture was stirred at room temperature for 24 hours. To the resulting reaction solution, 100 mL of water and 20 mL of hydrochloric acid were added, and the obtained solid was filtered and washed with water to obtain 35.0 g of Synthetic Intermediate G (yield: 96%).

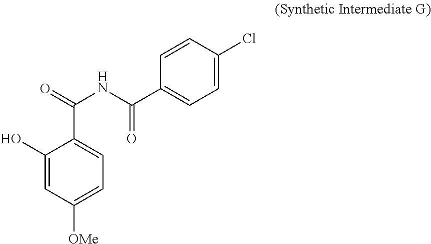

Acetonitrile (200 mL) and 9.6 g of sulfuric acid were added to 20.0 g of Synthetic Intermediate G, and the mixture was stirred at 90° C. for 4 hours. To the resulting reaction solution, 80 mL of triethylamine was added, and the mixture was cooled to room temperature. The obtained solid was filtered and washed with water to obtain 17.1 g of Synthetic Intermediate H (yield: 91%).

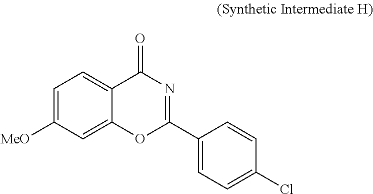

Methanol (100 mL) and 3.7 g of 28% sodium methoxide methanol solution were added to 3.0 g of benzamidine hydrochloride. To this solution, 5.0 g of Synthetic Intermediate H was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.5 g of Compound (4) (yield: 96%). MS: m/z 390 (M+).

¹H NMR (CDCl₃): δ6.54-6.55 (1H), δ6.61-6.63 (1H), δ7.53-7.67 (5H), δ8.60-8.62 (5H), δ13.26 (1H). λmax=340 nm (EtOAc).

### Synthesis Example 5

### Preparation of Compound (5)

Acetonitrile (80 mL) and 36.4 g of DBU were added to 20.0 g of 4-methoxysalicylamide and dissolved. To this solution, 16.8 g of benzoyl chloride was added, and the mixture was stirred at room temperature for 24 hours. To the resulting reaction solution, 100 mL of water and 20 mL of 35% hydrochloric acid were added, and the obtained solid was filtered and washed with water to obtain 29.5 g of Synthetic Intermediate I (yield: 91%).

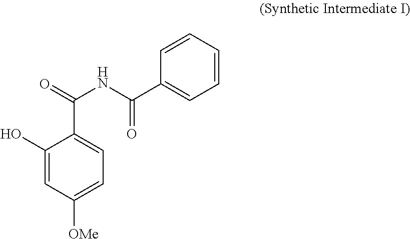

Acetonitrile (250 mL) and 13.5 g of sulfuric acid were added to 25.0 g of Synthetic Intermediate I, and the mixture was stirred at 90° C. for 4 hours. To the resulting reaction solution, 100 mL of triethylamine was added, and the mixture was cooled to room temperature. The obtained solid was filtered and washed with water to obtain 21.1 g of Synthetic Intermediate J (yield: 91%).

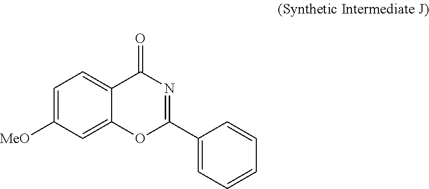

Methanol (100 mL) and 3.4 g of 28% sodium methoxide methanol solution were added to 3.5 g of 4-amidinobenzamide hydrochloride. To this solution, 4.0 g of Synthetic Intermediate J was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 5.8 g of Compound (5) (yield: 92%). MS: m/z 399 (M+).

¹H NMR (CDCl₃): δ6.57 (1H), δ6.63-6.65 (1H), δ7.58-7.66 (3H), δ8.00-8.02 (2H), δ8.64-8.66 (3H), δ8.74 (2H), δ13.41 (1H). λmax=340 nm (EtOAc).

### Synthesis Example 6

### Preparation of Compound (27)

Butanol (27.5 g), 0.13 g of NaOMe and 100 mL of xylene were added to 10 g of Compound (1), and the mixture was stirred at 90° C. for 6 hours under reduced pressure. To the resulting reaction solution, water and ethyl acetate were added and stirred, and the organic phase separated by liquid separation was concentrated. The obtained residue was crystallized from hexane/isopropyl alcohol (volume ratio: 1:10) to obtain 10.5 g of Compound (27) (yield: 95%). MS: m/z 456 (M+).

### Synthesis Example 7

### Preparation of Compound (29)

2-Ethylhexanol (31.6 g), 0.13 g of NaOMe and 100 mL of xylene were added to 10 g of Compound (1), and the mixture was stirred at 90° C. for 6 hours under reduced pressure. To the resulting reaction solution, water and ethyl acetate were added and stirred, and the organic phase separated by liquid separation was concentrated. The obtained residue was crystallized from hexane/isopropyl alcohol (volume ratio: 1:10) to obtain 11.5 g of Compound (29) (yield: 93%). MS: m/z 512 (M+).

### Synthesis Example 8

### Preparation of Compound (32)

Fine Oxocol 180N (produced by Nissan Chemical Industries, Ltd.) (9.8 g), 0.13 g of NaOMe and 100 mL of xylene were added to 10 g of Compound (1), and the mixture was stirred at 90° C. for 6 hours under reduced pressure. To the resulting reaction solution, water and ethyl acetate were added and stirred, and the organic phase separated by liquid separation was concentrated. The obtained residue was crystallized from hexane/isopropyl alcohol (volume ratio: 1:10) to obtain 15.1 g of Compound (32) (yield: 96%). MS: m/z 652 (M+). λmax=340 nm (EtOAc).

### Synthesis Example 9

### Preparation of Compound (63)

Methanol (100 mL), 15.8 g of 28% sodium methoxide methanol solution and 14.6 g of methyl 4-amidinobenzoate hydrochloride were added to 10.0 g of phenyl 4-methoxysalicylate, and this solution was stirred at 60° C. for 5 hours. The resulting reaction solution was cooled to room temperature, and 0.2 mL of 35% hydrochloric acid was added thereto. The obtained solid was filtered and washed with water and methanol to obtain 18.0 g of Compound (63) (yield: 93%). MS: m/z 472 (M+).

### Synthesis Example 10

### Preparation of Compound (64)

Methanol (100 mL) and 3.8 g of 28% sodium methoxide methanol solution were added to 4.2 g of methyl 4-amidinobenzoate hydrochloride. To this solution, 5.0 g of Synthetic Intermediate D was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 7.5 g of Compound (64) (yield: 95%). MS: m/z 439 (M+).

### Synthesis Example 11

### Preparation of Compound (65)

Methanol (100 mL) and 3.4 g of 28% sodium methoxide methanol solution were added to 3.6 g of 4-amidinobenzamide hydrochloride. To this solution, 5.0 g of Synthetic Intermediate B was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.9 g of Compound (65) (yield: 94%). MS: m/z 457 (M+).

### Synthesis Example 12

### Preparation of Compound (75)

Acetonitrile (80 mL) and 44.4 g of DBU were added to 20.0 g of salicylamide and dissolved. To this solution, 29.0 g of methyl 4-(chloroformyl)benzoate was added, and the mixture was stirred at room temperature for 24 hours. To the resulting reaction solution, 100 mL of water and 20 mL of hydrochloric acid were added, and the obtained solid was filtered and washed with water to obtain 40.0 g of Synthetic Intermediate K (yield: 92%).

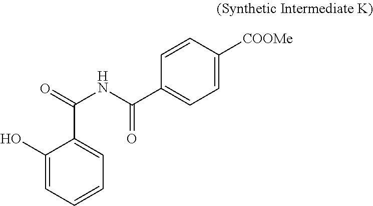

Acetonitrile (200 mL) and 9.4 g of sulfuric acid were added to 20.0 g of Synthetic Intermediate K, and the mixture was stirred at 90° C. for 4 hours. To the resulting reaction solution, 80 mL of triethylamine was added, and the mixture was cooled to room temperature. The obtained solid was filtered and washed with water to obtain 18.2 g of Synthetic Intermediate L (yield: 97%).

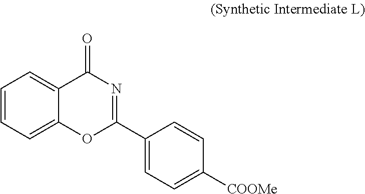

Methanol (100 mL) and 3.8 g of 28% sodium methoxide methanol solution were added to 3.1 g of benzamidine hydrochloride. To this solution, 5.0 g of Synthetic Intermediate L was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.4 g of Compound (75) (yield: 94%). MS: m/z 384 (M+).

### Synthesis Example 13

### Preparation of Compound (80)

Acetonitrile (80 mL) and 40.3 g of DBU were added to 20.0 g of 2-hydroxy-4-methylbenzamide and dissolved. To this solution, 25.8 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 36.3 g of Synthetic Intermediate M (yield: 89%).

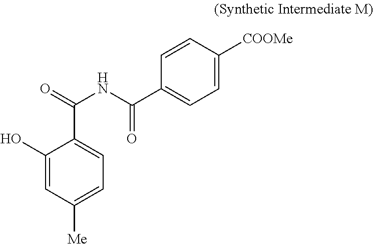

Acetonitrile (200 mL) and 9.1 g of sulfuric acid were added to 20.0 g of Synthetic Intermediate M, and the mixture was stirred at 90° C. for 4 hours. To the resulting reaction solution, 80 mL of triethylamine was added, and the mixture was cooled to room temperature. The obtained solid was filtered and washed with water to obtain 17.6 g of Synthetic Intermediate N (yield: 93%).

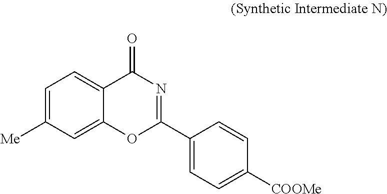

Methanol (100 mL) and 3.7 g of 28% sodium methoxide methanol solution were added to 2.9 g of benzamidine hydrochloride. To this solution, 5.0 g of Synthetic Intermediate N was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.3 g of Compound (75) (yield: 94%). MS: m/z 398 (M+).

### Synthesis Example 14

### Preparation of Compound (81)

Acetonitrile (80 mL) and 29.7 g of DBU were added to 20.0 g of 2-hydroxy-4-(trifluoromethyl)benzamide and dissolved. To this solution, 19.4 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 34.1 g of Synthetic Intermediate O (yield: 95%).

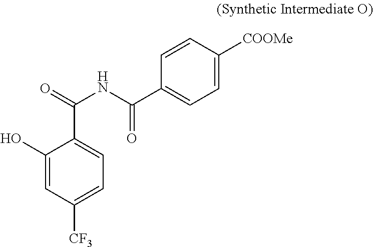

Acetonitrile (200 mL) and 6.9 g of sulfuric acid were added to 20.0 g Synthetic Intermediate O, and the mixture was stirred at 90° C. for 4 hours. To the resulting reaction solution, 80 mL of triethylamine was added, and the mixture was cooled to room temperature. The obtained solid was filtered and washed with water to obtain 18.4 g of Synthetic Intermediate P (yield: 97%).

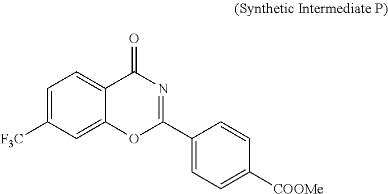

Methanol (100 mL) and 3.4 g of 28% sodium methoxide methanol solution were added to 2.3 g of benzamidine hydrochloride. To this solution, 5.0 g of Synthetic Intermediate P was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 5.9 g of Compound (81) (yield: 91%). MS: m/z 452 (M+).

### Synthesis Example 15

### Preparation of Compound (90)

Acetonitrile (80 mL) and 36.4 g of DBU were added to 20.0 g of 2-hydroxy-5-methoxybenzamide and dissolved. To this solution, 23.8 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 38.0 g of Synthetic Intermediate Q (yield: 96%).

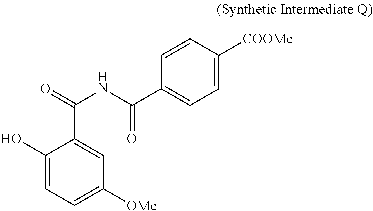

Acetonitrile (200 mL) and 8.9 g of sulfuric acid were added to 20.0 g of Synthetic Intermediate Q, and the mixture was stirred at 90° C. for 4 hours. To the resulting reaction solution, 80 mL of triethylamine was added, and the mixture was cooled to room temperature. The obtained solid was filtered and washed with water to obtain 18.1 g of Synthetic Intermediate R (yield: 96%).

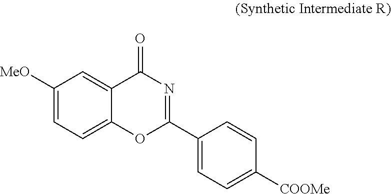

Methanol (100 mL) and 3.4 g of 28% sodium methoxide methanol solution were added to 2.8 g of benzamidine hydrochloride. To this solution, 5.0 g of Synthetic Intermediate R was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.2 g of Compound (90) (yield: 93%). MS: m/z 414 (M+).

### Synthesis Example 16

### Preparation of Compound (93)

Acetonitrile (80 mL) and 35.4 g of DBU were added to 20.0 g of 2-hydroxy-5-chlorobenzamide and dissolved. To this solution, 23.1 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 38.1 g of Synthetic Intermediate S (yield: 98%).

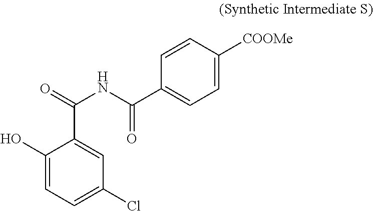

Acetonitrile (200 mL) and 9.0 g of sulfuric acid were added to 20.0 g of Synthetic Intermediate S, and the mixture was stirred at 90° C. for 4 hours. To the resulting reaction solution, 80 mL of triethylamine was added, and the mixture was cooled to room temperature. The obtained solid was filtered and washed with water to obtain 18.3 g of Synthetic Intermediate T (yield: 97%).

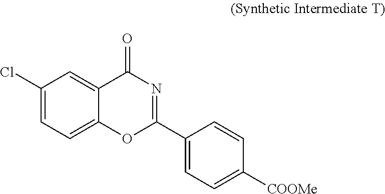

Methanol (100 mL) and 3.3 g of 28% sodium methoxide methanol solution were added to 2.5 g of benzamidine hydrochloride. To this solution, 5.0 g of Synthetic Intermediate T was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.1 g of Compound (93) (yield: 92%). MS: m/z 418 (M+).

### Synthesis Example 17

### Preparation of Compound (96)

Acetonitrile (80 mL) and 36.4 g of DBU were added to 20.0 g of 2-hydroxy-3-methoxybenzamide and dissolved. To this solution, 23.8 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 37.8 g of Synthetic Intermediate U (yield: 95%).

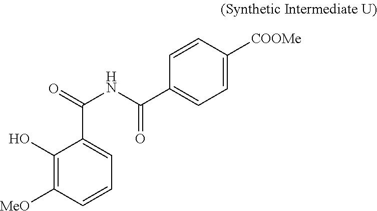

Acetonitrile (200 mL) and 8.9 g of sulfuric acid were added to 20.0 g of Synthetic Intermediate U, and the mixture was stirred at 90° C. for 4 hours. To the resulting reaction solution, 80 mL of triethylamine was added, and the mixture was cooled to room temperature. The obtained solid was filtered and washed with water to obtain 17.7 g of Synthetic Intermediate V (yield: 94%).

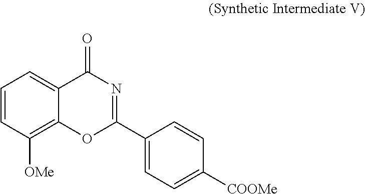

Methanol (100 mL) and 3.4 g of 28% sodium methoxide methanol solution were added to 2.8 g of benzamidine hydrochloride. To this solution, 5.0 g of Synthetic Intermediate V was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.5 g of Compound (96) (yield: 98%). MS: m/z 414 (M+).

### Synthesis Example 18

### Preparation of Compound (107)

Acetonitrile (80 mL) and 32.4 g of DBU were added to 20.0 g of 3-hydroxy-2-naphthamide and dissolved. To this solution, 21.2 g of methyl 4-(chloroformyl)benzoate was added, and the mixture was stirred at room temperature for 24 hours. To the resulting reaction solution, 100 mL of water and 20 mL of 35% hydrochloric acid were added, and the obtained solid was filtered and washed with water to obtain 35.1 g of Synthetic Intermediate W (yield: 94%).

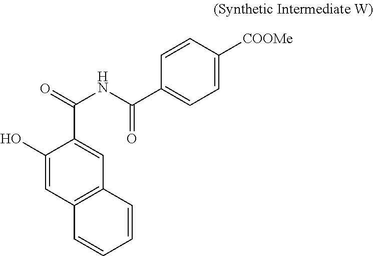

Acetonitrile (200 mL) and 9.1 g of sulfuric acid were added to 20.0 g of Synthetic Intermediate W, and the mixture was stirred at 90° C. for 4 hours. To the resulting reaction solution, 80 mL of triethylamine was added, and the mixture was cooled to room temperature. The obtained solid was filtered and washed with water to obtain 17.9 g of Synthetic Intermediate X (yield: 94%).

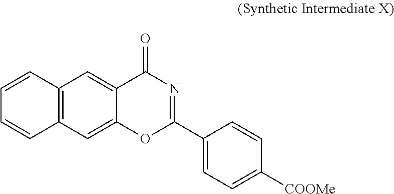

Methanol (100 mL) and 3.0 g of 28% sodium methoxide methanol solution were added to 2.3 g of benzamidine hydrochloride. To this solution, 5.0 g of Synthetic Intermediate X was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.1 g of Compound (107) (yield: 94%). MS: m/z 434 (M+).

### Synthesis Example 19

### Preparation of Compound (17)

Acetonitrile (80 mL) and 36.4 g of DBU were added to 20.0 g of 4-methoxysalicylamide and dissolved. To this solution, 19.8 g of 3-cyanobenzoyl chloride was added, and the mixture was stirred at room temperature for 24 hours. To the resulting reaction solution, 100 mL of water and 20 mL of 35% hydrochloric acid were added, and the obtained solid was filtered and washed with water to obtain 34.5 g of Synthetic Intermediate Y (yield: 97%).

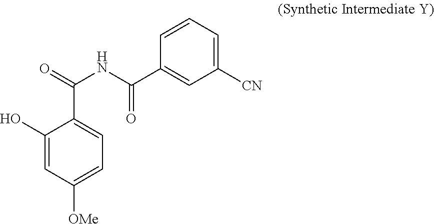

Acetonitrile (200 mL) and 9.9 g of sulfuric acid were added to 20.0 g of Synthetic Intermediate Y, and the mixture was stirred at 90° C. for 4 hours. To the resulting reaction solution, 80 mL of triethylamine was added, and the mixture was cooled to room temperature. The obtained solid was filtered and washed with water to obtain 16.7 g of Synthetic Intermediate Z (yield: 89%).

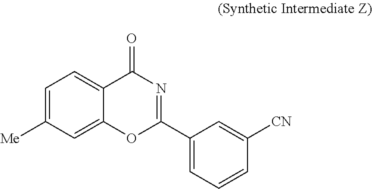

Methanol (100 mL) and 3.8 g of 28% sodium methoxide methanol solution were added to 3.1 g of benzamidine hydrochloride. To this solution, 5.0 g of Synthetic Intermediate Z was added, and the mixture was stirred at 60° C. for 3 hours. The resulting reaction solution was cooled to room temperature, and 0.2 mL of 35% hydrochloric acid was added thereto. The obtained solid was filtered and washed with water and methanol to obtain 6.5 g of Compound (2) (yield: 96%). MS: m/z 381 (M+). λmax=343 nm (EtOAc).

### 2. Examples

Various additives in respective blending amounts shown in Table 1 were mixed by a blender with 100 parts by mass of a polycarbonate resin (viscosity average molecular weight: 24,000) produced from bisphenol A and phosgene by the interfacial condensation polymerization, and melt-kneaded by a vented twin-screw extruder to obtain a pellet. After a pre-mixture of the polycarbonate resin and the additives each in a concentration of 10 to 100 times the blending amount was prepared, this was totally mixed by the blender. The vented twin-screw extrude used was TEX30α (complete engagement, rotation in the same direction, double threaded screws) manufactured by Japan Steel Works, Ltd. The extruder was of a type having one kneading zone before the vent port. The extrusion conditions were a delivery rate of 30 kg/h, a screw revolution of 150 rpm, a vent vacuum degree of 3 Pka and an extrusion temperature from the first feed port to the die portion of 280° C.

The obtained pellet was dried by a hot air circulating drier at 120° C. for 5 hours and shaped into a 50 mm-square plate having a thickness of 2 mm by an injection molding machine at a cylinder temperature of 340° C. and a mold temperature of 80° C. The injection molding machine used was T-150D manufactured by FANUC Ltd. Light was irradiated on this shaped plate from a metal halide lamp (by cutting light at about 290 nm or less) (Eye Super UV Tester, trade name, manufactured by Iwasaki Electric Co., Ltd.) for 1,000 hours under the conditions of an illuminance of 90 mW/cm², a temperature of 63° C. and a humidity of 50%, and the change in color hue caused here is shown in Table 1. A indicates no change in color hue, B indicates slight coloring, and C indicates serious coloring.

TABLE 1

| | | | | | Hindered | | |
|---|---|---|---|---|---|---|---|
| | | | Phosphorus-Based | | Phenol-Based | | Change in |
| | Ultraviolet Absorber | | Stabilizer | | Stabilizer | | Color Hue |
| | | Parts by | | Parts by | | Parts by | of Molded |
| | Compound | mass | Compound | mass | Compound | mass | Article |
| Example 1 | Compound (1) | 0.5 | P-1 | 0.05 | H-1 | 0.05 | A |
| Example 2 | Compound (2) | 0.5 | P-1 | 0.05 | H-1 | 0.05 | A |
| Example 3 | Compound (3) | 0.5 | P-1 | 0.05 | H-1 | 0.05 | A |
| Example 4 | Compound (4) | 0.5 | P-1 | 0.05 | H-1 | 0.05 | A |
| Example 5 | Compound (5) | 0.5 | P-1 | 0.05 | H-1 | 0.05 | A |
| Example 5 | Compound (17) | 0.5 | P-1 | 0.05 | H-1 | 0.05 | A |
| Example 6 | Compound (29) | 0.5 | P-1 | 0.05 | H-1 | 0.05 | A |
| Example 7 | Compound (32) | 0.5 | P-1 | 0.05 | H-1 | 0.05 | A |
| Example 8 | Compound (63) | 0.5 | P-1 | 0.05 | H-1 | 0.05 | A |
| Example 9 | Compound (64) | 0.5 | P-1 | 0.05 | H-1 | 0.05 | A |
| Example 10 | Compound (65) | 0.5 | P-1 | 0.05 | H-1 | 0.05 | A |
| Example 11 | Compound (75) | 0.5 | P-1 | 0.05 | H-1 | 0.05 | A |
| Example 12 | Compound (80) | 0.5 | P-1 | 0.05 | H-1 | 0.05 | A |
| Example 13 | Compound (81) | 0.5 | P-1 | 0.05 | H-1 | 0.05 | A |
| Example 14 | Compound (81) | 0.5 | P-1 | 0.05 | H-1 | 0.05 | A |
| Example 15 | Compound (90) | 0.5 | P-1 | 0.05 | H-1 | 0.05 | A |
| Example 16 | Compound (81) | 0.5 | P-1 | 0.05 | H-1 | 0.05 | A |
| Example 17 | Compound (93) | 0.5 | P-1 | 0.05 | H-1 | 0.05 | A |
| Example 18 | Compound (107) | 0.5 | P-1 | 0.05 | H-1 | 0.05 | A |
| Example 19 | Compound (17) | 0.5 | P-2 | 0.05 | H-1 | 0.05 | A |
| Example 20 | Compound (17) | 0.5 | P-1 | 0.05 | H-2 | 0.05 | A |
| Example 21 | Compound (17) | 0.5 | P-1 | 0 | H-1 | 0.05 | B |
| Example 22 | Compound (17) | 0.5 | P-1 | 0.05 | H-1 | 0 | B |
| Comparative | Compound (17) | 0 | P-1 | 0.05 | H-1 | 0.05 | C |
| Example 1 | | | | | | | |
| Comparative | Comparative | 0.5 | P-1 | 0.05 | H-1 | 0.05 | C |
| Example 2 | Compound 1 | | | | | | |
| Comparative | Comparative | 0.5 | P-1 | 0.05 | H-1 | 0.05 | C |
| Example 3 | Compound 2 | | | | | | |

In Table 1, the denotations of additive are as follows.
(Phosphorus-Based Stabilizer)
P-1: Phosphonite-based heat stabilizer (Sandostab P-EPQ, produced by Sandoz)
P-2: Phosphite-based thermal stabilizer (Irgafos 168, produced by Ciba Specialty Chemicals)
(Hindered Phenol-Based Stabilizer)
H-1: Hindered phenol-based antioxidant (Irganox 1076, produced by Ciba Specialty Chemicals)
H-2: Hindered phenol-based antioxidant (Irganox 1010, produced by Ciba Specialty Chemicals)

As apparent from the results in Table 1, the polycarbonate resin composition of the present invention is free from coloring of the molded article and excellent in the weather resistance and therefore, can be suitably used also for the outdoor application over a long period of time.

Furthermore, after drying each of the pellets obtained in Examples and Comparative Examples in the same manner as above, a head lamp lens was prepared by an injection molding machine (SG260M-HP, manufactured by Sumitomo Heavy Industries, Ltd.) under the conditions of a cylinder temperature of 300° C. and a mold temperature of 80° C. The head lamp lenses of Examples had a good appearance in terms of color hue, transparency and the like. Also, light was irradiated on the head lamp lens from a metal halide lamp (by cutting light at about 290 nm or less) (Eye Super UV Tester, trade name, manufactured by Iwasaki Electric Co., Ltd.) for 1,000 hours under the conditions of an illuminance of 90 mW/cm², a temperature of 63° C. and a humidity of 50%, as a result, the color hue was not changed in the head lamp lenses of Examples, but coloring was observed in those of Comparative Examples.

The entire disclosure of Japanese Patent Application No. 2009-223467 filed on Sep. 28, 2009, from which the benefit of foreign priority has been claimed in the present application, is incorporated herein by reference, as if fully set forth.

What is claimed is:

1. A polycarbonate resin composition containing a compound represented by the following formula (1): 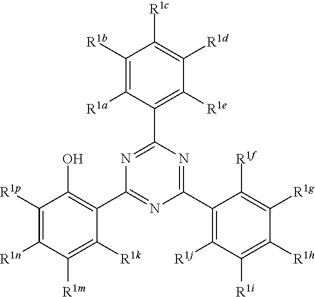
wherein each of R^{1a}, R^{1b}, R^{1c}, R^{1d} and R^{1e} independently represents a hydrogen atom or a monovalent substituent excluding —OH, at least one of the substituents represents a substituent having a positive Hammett's σp value, and the substituents may be combined each other to form a ring;
each of R^{1f}, R^{1g}, R^{1h}, R¹ⁱ and R^{1j} independently represents a hydrogen atom or a monovalent substituent excluding —OH, and the substituents may be combined each other to form a ring; and
each of R^{1k}, R^{1m}, R¹ⁿ and R^{1p} independently represents a hydrogen atom or a monovalent substituent, and the substituents may be combined each other to form a ring.

2. The polycarbonate resin composition according to claim 1, wherein said monovalent substituent is a halogen atom, a substituted or unsubstituted alkyl group having a carbon number of 1 to 20, a cyano group, a carboxyl group, a substituted or unsubstituted alkoxycarbonyl group, a substituted or unsubstituted carbamoyl group, a substituted or unsubstituted alkylcarbonyl group, a nitro group, a substituted or unsubstituted amino group, a hydroxy group, an alkoxy group having a carbon number of 1 to 20, a substituted or unsubstituted aryloxy group, a substituted or unsubstituted sulfamoyl group, a thiocyanate group, or a substituted or unsubstituted alkylsulfonyl group,
and in the case of having a substituent, the substituent is a halogen atom, an alkyl group having a carbon number of 1 to 20, a cyano group, a carboxyl group, an alkoxycarbonyl group, a carbamoyl group, an alkylcarbonyl group, a nitro group, an amino group, a hydroxy group, an alkoxy group having a carbon number of 1 to 20, an aryloxy group, a sulfamoyl group, a thiocyanate group, or an alkylsulfonyl group.

3. The polycarbonate resin composition according to claim 1, wherein R^{1c} is a substituent having a positive Hammett's σp value.

4. The polycarbonate resin composition according to claim 1, wherein said Hammett's σp value is from 0.1 to 1.2.

5. The polycarbonate resin composition according to claim 1, wherein said substituent having a positive Hammett's σp value is a group selected from COOR^{r}, CONR^{s}₂, CN, CF₃, a halogen atom, NO₂, SO₂R^{t} and SO₃M, wherein each of R^{r}, R^{s} and R^{t} represents a hydrogen atom or a monovalent substituent, and M represents a hydrogen atom or an alkali metal.

6. The polycarbonate resin composition according to claim 1, wherein said substituent having a positive Hammett's σp value is COOR^{r}, wherein R^{r} represents a hydrogen atom or a monovalent substituent.

7. The polycarbonate resin composition according to claim 1, wherein R^{1c} is CN.

8. The polycarbonate resin composition according to claim 1, wherein R¹ⁿ is OR^{u} wherein R^{u} represents a hydrogen atom or a monovalent substituent.

9. The polycarbonate resin composition according to claim 8, wherein R^{u} is an alkyl group having a carbon number of 1 to 20.

10. The polycarbonate resin composition according to claim 1, wherein pKa is from −5.0 to −7.0.

11. The polycarbonate resin composition according to claim 1, which further contains a phosphorus-based stabilizer.

12. The polycarbonate resin composition according to claim 11, wherein the compound represented by formula (1) is contained in an amount of from 0.05 to 3 parts by mass and the phosphorus-based stabilizer is contained in an amount of from 0.0005 to 0.3 parts by mass, per 100 parts by mass of the polycarbonate resin composition.

13. The polycarbonate resin composition according to claim 1, which further contains a hindered phenol-based stabilizer.

14. The polycarbonate resin composition according to claim 1, wherein the viscosity average molecular weight of the polycarbonate resin is from 10,000 to 50,000.

15. A molded article comprising the polycarbonate resin composition according to claim 1.
